(19) United States
(12) Patent Application Publication
(10) Pub. No.: US 2026/0016412 A1
(43) Pub. Date: Jan. 15, 2026

(54) METHODS AND SYSTEMS FOR OPTICAL CHARACTERISATION OF A BULK SCATTERING MEDIUM

(71) Applicants: CENTRE NATIONAL DE LA RECHERCHE SCIENTIFIQUE, Paris (FR); ECOLE SUPERIEURE DE PHYSIQUE ET DE CHIMIE INDUSTRIELLES DE LA VILLE DE PARIS, Paris 5 (FR)

(72) Inventors: Alexandre AUBRY, IVRY SUR SEINE (FR); Victor BAROLLE, Paris (FR); Paul BALONDRADE, Paris (FR); Mathias Alexandre FINK, MEUDON (FR); Albert Claude BOCCARA, Paris (FR); Ulysse NAJAR, ARCUEIL (FR)

(73) Assignees: CENTRE NATIONAL DE LA RECHERCHE SCIENTIFIQUE, Paris (FR); ECOLE SUPERIEURE DE PHYSIQUE ET DE CHIMIE INDUSTRIELLES DE LA VILLE DE PARIS, Paris 5 (FR)

(21) Appl. No.: 18/994,822

(22) PCT Filed: Jul. 7, 2023
(86) PCT No.: PCT/EP2023/068840

§ 371 Date: Jan. 15, 2025

(30) Foreign Application Priority Data
Jul. 18, 2022 (FR) 2207334

(51) Int. Cl. G01N 21/49; G01N 21/47

(52) U.S. Cl. CPC G01N 21/49; G01N 2021/4735

(57) ABSTRACT

A method for the optical characterization of a sample, by positioning the sample in a field of view of a first microscope objective located in an object arm of an interferometer; generating, by an illuminating device, a first plurality of Nᵢₙ incident light waves; for each incident light wave of a given wavefront, acquiring a second plurality N_{ω} of interference signals, each interference signal resulting from the interference between a wave backscattered by the sample and a reference wave, the interference signals acquired according to one example for different N_{ω} frequencies; determining a polychromatic reflection matrix with all of the interference signals acquired for the Nᵢₙ incident light waves and the N_{ω} frequencies; numerically determining, on the basis of the polychromatic reflection matrix, a focused bulk reflection matrix; determining, on the basis of this first focused bulk reflection matrix, at least one map having a physical parameter of the sample.

### TECHNICAL FIELD

The present description relates to methods and systems for the optical characterization of a bulk scattering medium. The present description applies in particular, but not exclusively, to biomedical imaging for the characterization of biological tissues.

### BACKGROUND

The optical characterization of bulk scattering media such as biological tissues is a research discipline at the intersection of physics and biology. The aim is to image the structures that make up biological tissues with micrometric resolution limited by diffraction, i.e. of the order of optical wavelengths. The general principle is as follows: a light wave illuminates the sample, and then the light scattered by the structures in the medium is collected by a set of lenses to form a magnified image of the tissue, in a camera for example. The microscopes known to the general public are generally transmission microscopes, due to their simplicity of design and use. However, they are limiting for in-vivo imaging, since it is necessary to place the source and camera on opposite sides of the sample. The reflection approach is thus favored for applications including microscopic in-vivo imaging in particular.

For thin samples (L<50 μm), the wave backscattered by the sample is true to the reflectivity of the object; only the numerical aperture of the optical system determines the axial and transverse resolution of the microscopic image. However, when it comes to imaging deep tissue, the phenomenon of multiple scattering becomes limiting. Specifically, biological samples are heterogeneous media, the optical index of which fluctuates across different spatial scales. These index inhomogeneities not only negatively affect the propagation of the light wave (aberration), thereby reducing image contrast and resolution, but also limit the number of useful photons that can be collected (multiple scattering). Since the contribution of single scattering decreases exponentially with depth, it becomes impossible to differentiate it from the contributions of photons that are aberrated and photons multiply scattered by the sample beyond a characteristic distance corresponding to the scattering mean free path Iₛ (typically 50-100 μm in tissues).

To overcome this problem, two types of microscopes were developed: the confocal microscope in the early 1960s and the interferometric microscope in the early 1990s. By spatially filtering the scattered photons, confocal microscopes increase the resolution and penetration depth of conventional microscopes (typically 100-300 μm). Interferometric microscopy, particularly OCT (optical coherence tomography), adds temporal filtering to the spatial filtering of confocal microscopy. This makes it possible to further increase accessible performance down to a few Iₛ (i.e. ˜100-500 μm). However, despite the spatio-temporal windowing of photons, interferometric microscope performance in terms of resolution and penetration depth is still limited by aberrations and multiple scattering.

There is therefore still the general problem of imaging biological samples in three dimensions, beyond a few Iₛ, with a resolution limited only by diffraction. In the early 2000s, inspired by pioneering work in astronomy, aberration correction methods were developed for optical microscopy. In astronomy, fluctuations in the index of atmospheric layers create wavefront distortions and negatively affect the quality of images of the sky formed from Earth. Adaptive optics methods, based on wavefront measurement combined with a wavefront control device (typically an array of deformable mirrors), can compensate for wavefront distortion and thus improve resolution. For this, a guide star or bright spot projected into the sky is used to optimize correction. These adaptive optics techniques were then transposed to optical microscopy with the advent of small deformable mirrors and SLMs (spatial light modulators). However, these methods have a number of drawbacks. Firstly, the decorrelation time for biological tissues requires rapid compensation for aberrations, and limits the number of angular and/or spatial degrees of freedom of wavefront measurement and control devices. Adaptive optics in biological environments is therefore limited to compensating for relatively low orders of aberration. An even more limiting factor is the restricted field of view over which aberration compensation is effective. It corresponds to what is commonly referred to as an isoplanatic zone, i.e. a zone up to and from which incident and reflected wavefronts undergo the same distortions. However, the size of these isoplanatic zones becomes smaller than a dozen micrometers at a depth of the order of a transport mean free path Iₜ (typically 1 mm in biological tissues). Accessing a correction for the entire field of view requires repeating the adaptive optics process for each isoplanatic zone, making highly resolved imaging over large fields of view and at great depths unrealistic. To counter the limited size of isoplanatic zones, so-called multi-conjugate adaptive optics devices have been developed, but their experimental implementation is particularly complex. Finally, deep multiple scattering (i.e. beyond a transport mean free path Iₜ) remains a problem that is not addressed by adaptive optics.

A third approach has been developed, based neither on the generation of an artificial star, nor on wavefront optimization based on an image quality criterion. This is a matrix approach to optical imaging and aberration correction. The matrix approach to the propagation of light waves in heterogeneous media was first developed for transmission, in particular for communication through highly scattering media—see the article by S. M. Popoff et al. [Ref. 1].

Recently, the matrix approach was developed in reflection for imaging through highly scattering media—see article by A. Badon et al. [Ref. 2], this approach involves the experimental determination of a time-windowed “focal plane” or “focused” reflection matrix defined between a source plane and an image plane, conjugate with an object focal plane of a microscope objective.

In practice, in the main experimental setup described in [ref. 2], a laser beam from a femtosecond laser source is spatially shaped by a spatial light modulator (SLM) acting as a dynamic diffraction grating. A set of plane waves is then emitted by the SLM, the plane waves being focused at different focal points each marked by a vector rᵢₙ of the object focal plane of the microscope objective. For each focal point rᵢₘ, the reflected field Eᵣ(uₒᵤₜ.rᵢₙ,t) is collected through the same microscope objective and interferes with a reference wave E₀(uₒᵤₜ,0,t) in a two-dimensional acquisition device, for example a CCD camera, arranged in a plane conjugate with the pupil plane of the microscope objective and identified by the vector uₒᵤₜ. The interference pattern between these two waves, integrated over time t, gives access to the coefficients R(uₒᵤₜ. rᵢₙ) of a column of the time-windowed reflection matrix Rᵤᵣ:

$$R ( {u}_{out} , {r}_{in} ) = \int dt \text{?} ( {u}_{out} \text{?} {r}_{in} \text{?} t ) \times \text{?} ( {u}_{out} , 0 , t + τ ) \qquad [ Math 1 ]$$

$$\text{?} \text{indicates text missing or illegible when filed}$$

where the symbol * denotes the conjugate matrix. In practice, the amplitude and phase of each coefficient R(uₒᵤₜ, rᵢₙ) are recorded using phase-shifting interferometry. The time of flight T is controlled by the length of the reference arm of the interferometer by means of a mirror, the position of which is adjusted by a piezoelectric actuator (PZT). The time of flight is adjusted to the ballistic time for most applications, so as to eliminate most of the multiply scattered photons and retain only those singly scattered by the reflectors contained in the focal plane of the microscope objective. For each entrance focal point rᵢₙ in the focal plane, the reflection coefficient R(uₒᵤₜ,rᵢₙ) is recorded in a plane conjugate with that of the exit microscope objective pupil (identified by the vector uₒᵤₜ). A two-dimensional Fourier transform on the coordinate uₒᵤₜ makes it possible to determine the reflection coefficient R(rₒᵤₜ, rᵢₙ) in a plane conjugate with the exit focal plane, identified by the vector rₒᵤₜ. For each entrance focal point rᵢₙ in the focal plane, the reflection coefficient R(rₒᵤₜ, rᵢₙ) is recorded and stored along a column vector. Finally, the set of column vectors forms the reflection matrix Rᵣᵣ in the focal plane. This produces a time-windowed focused reflection matrix, the diagonal elements (rᵢₙ=rₒᵤₜ) of which form an “face-on” slice of the sample image as it would be obtained in full-field OCT (for a description of full-field OCT imaging, see, for example, published patent application US20040061867 [Ref.3]). In addition, the off-diagonal elements provide information on the level of aberration and multiple scattering.

Based on this focal plane reflection matrix in the focal plane, a novel matrix approach for optical imaging was described, allowing aberrations to be corrected simultaneously over multiple isoplanatism domains of the field of view. See, for example, US20210310787 [Ref. 4]; in [Ref. 4], a novel matrix, known as a “distortion matrix”, was introduced for characterizing heterogeneous media. This matrix contains only the distorted part of the wavefronts backscattered by the sample for a set of focal points rᵢₙ. This matrix makes it possible to reveal the spatial correlations of the light field that are linked to the isoplanatism. Analyzing the correlations between these different wavefronts makes it possible to extract local aberration laws for the entire field of view. This gives access to the transmission matrices between the object focal plane within the sample and the source and image planes located outside it. Once phase-conjugated or inverted, these matrices provide all of the focusing laws needed to optimally and locally correct aberrations at every point in the field of view.

The characterization method described in [Ref. 4] is, however, limited to imaging a single transverse plane, referred to as the coherence plane, in the sample. To obtain a three-dimensional image of the sample, it would be necessary to scan it axially. Axial scanning limits the speed of acquisition and therefore the accessible volume, particularly for in-vivo applications or dynamic imaging of cellular tissues, for example.

Above all, the applicants have shown that the characterization method described in [Ref. 4] only allows transverse correction of aberrations for a coherence plane of which the position is dictated by that of the reference mirror in the interferometric setup. However, optical index inhomogeneities in the medium bring about axial displacement and deformation of the coherence volume with respect to its position and flatness in comparison with that expected if the optical index of the medium were homogeneous. In other words, the object focal plane of the microscope objective and the coherence plane are no longer coincident in the case of optical index inhomogeneities in the medium. This limits the signal-to-noise ratio, generating large transverse aberrations and axial distortions in the image.

The present description proposes methods and systems for the optical characterization of a bulk scattering medium, also based on a matrix approach, that allows ultra-fast volume characterization of the sample, typically in less than a second, and also provides access to reflectivity images of which the axial dimension is no longer dictated by the time of flight of the scattered photons but by the actual depth of the scatterers in the sample.

### SUMMARY

According to a first aspect, the present description relates to a method for the optical characterization of a sample formed of a bulk scattering medium, the method comprising:
a step of positioning said sample in a field of view of a first microscope objective, said microscope objective being located in an object arm of a first interferometer, said first interferometer further comprising a reference arm;
a step of generating, by means of an illuminating device comprising a wide spectral band light source, a first plurality of Niₙ incident light waves having different wavefronts;
for each incident light wave of given wavefront, a step of acquiring, by means of a detector comprising Nₒᵤₜ elementary detectors, a second plurality of interference signals, each interference signal resulting from the interference, in a detection plane of the detector, between a wave backscattered by the sample illuminated by said incident light wave and a reference wave from the reference arm, said interference signals being acquired for N_{ω} different frequencies or N_{ω} different path differences between the backscattered wave and the reference wave;
determining a three-dimensional polychromatic reflection matrix \tilde{R}_{ρu}=[\tilde{R}(ρₒᵤₜ, uᵢₙ, ω)] of size Nᵢₙ×Nₒᵤₜ×N_{ω}, said three-dimensional polychromatic reflection matrix comprising all of the interference signals acquired for the Nᵢₙ incident light waves and N_{ω} frequencies;
numerically determining, by applying a first propagator, on the basis of said polychromatic reflection matrix, at least a first focused volumetric reflection matrix, comprising a set of responses for the sample between source points and receiving points that are conjugate with voxels rᵢₙ(x′ᵢₙ, y′ᵢₙ, zᵢₙ) and rₒᵤₜ(x′ₒᵤₜ, y′ₒᵤₜ, Zₒᵤₜ) of the sample which are located at depths zᵢₙ and zₒᵤₜ in the sample, respectively;
determining, on the basis of said first focused volumetric reflection matrix, at least one map of a physical parameter of said sample.

In the present description, the field of view of the microscope objective comprises an object focal plane of said objective. The dimensions of the field of view are limited by the characteristics of the microscope objective, the dimensions of the detection surface and the magnification of an imaging device between the object focal plane and the detection surface. The dimensions of the field of view can also be adjusted according to the transverse extent of the sample the operator wishes to characterize.

In the present description, a wide spectral band source is a source of which the spectral bandwidth Δω is equal to or greater than a value Δωₘᵢₙ allowing a desired axial resolution δz to be obtained for determining the map of physical parameters: δz=2πc₀/(n̅Δωₘᵢₙ), where n̅ is the mean optical index of the sample and c₀ is the speed of light. According to exemplary embodiments, the spectral bandwidth of the source is between approximately 10 nm and approximately 400 nm. The source is, for example, but not limited to, a spectral scanning source or a wide spectral band source, e.g. a light-emitting diode (LED), a halogen source, a femtosecond laser, a superluminescent diode.

The applicants have shown that determining the focused volumetric reflection matrix, obtained on the basis of the polychromatic reflection matrix, makes it possible to avoid the axial and transverse distortions inherent to the techniques described in the prior art [Ref.4].

Indeed, it becomes possible to form, for example, a confocal image with a resolution limited only by diffraction, so as to make the coherence volume coincide with the geometric focal plane.

A map of a physical parameter of the sample is understood in the present description, unless specified to the contrary, as a planar or volumetric map of said parameter.

Thus, a map of a physical parameter of the sample thus comprises a face-on or volumetric reflection confocal image, a map of the reflective point spread function (or RPSF) around voxels of the sample, a planar or volumetric map of the single scattering rate, a planar or volumetric map of the multiple scattering rate, a planar or volumetric map of the optical index of the sample.

A face-on reflection confocal image is an estimator of the reflectivity of a cross section of the sample. A volumetric reflection confocal image is an estimator of the reflectivity of a volume of the sample. In the remainder of the description, a reflection confocal image may simply be referred to as a “confocal image”.

A voxel is defined as a volumetric resolution cell. In the present description, a voxel can also be referred to by its barycenter, called the “focal point”. The dimensions of a volumetric resolution cell are determined by the transverse resolution of an optical system defined by the set of optical elements that are located between the sample and the illumination and detection planes, and the axial resolution δz.

In the remainder of the description, the reflective point spread function around a focal point will simply be referred to as the “spread function around a focal point” or “RPSF at said focal point”. The “map of the spread function” refers to a map of the reflective point spread function (RPSF) around a plurality of focal points of the sample.

According to one or more embodiments, the optical characterization method according to the first aspect further comprises:
determining, on the basis of said focused volumetric reflection matrix, a first reflection confocal image;
determining, on the basis of said focused volumetric reflection matrix, a map of the spread function and determining a map of the position of the intensity maximum of each spread function;
   determining, on the basis of the first reflection confocal image and said map of the position of the intensity maximum, a second reflection confocal image corrected for an alignment and/or focusing defect of the first interferometer. Thus, the applicants have demonstrated a first advantage of determining the focused volumetric reflection matrix, in order to determine confocal images corrected for alignment and/or focusing defects of the first interferometer.

According to one or more exemplary embodiments, the optical characterization method according to the first aspect further comprises:
on the basis of said first focused volumetric reflection matrix, determining a plurality of maps of the spread function for a plurality of values of an integrated optical index of the sample;
on the basis of said plurality of maps of the spread function, determining a plurality of maps of the position of the intensity maximum of the spread function, each map being obtained for a value of the integrated optical index;
determining a map of the optimum value of the integrated optical index for which, at each focal point, the maximum intensity value of the spread function is the greatest;
numerically determining a second propagator based on said map of the optimum value of the integrated optical index; and
   determining a second focused volumetric reflection matrix using said second propagator.

In this description, the integrated optical index of the sample refers to the optical index of the sample integrated between a proximal surface of the sample (i.e. on the microscope objective side) and the focal point in question.

According to one or more exemplary embodiments, the method further comprises, on the basis of said map of the optimum value of the integrated optical index, determining a map of the optical index of the medium at each focal point. Said second propagator can then be determined on the basis of said optical index map. Thus, according to one or more exemplary embodiments, the optical characterization method according to the first aspect further comprises:
on the basis of said first focused volumetric reflection matrix, determining a plurality of maps of the spread function for a plurality of values of an integrated optical index of the sample;
on the basis of said plurality of maps of the spread function, determining a plurality of maps of the position of the intensity maximum of the spread function, each map being obtained for a value of the integrated optical index;
determining a map of the optimum value of the integrated optical index for which, at each focal point, the maximum intensity value of the spread function is the greatest;
on the basis of said map of the optimum value of the integrated optical index, determining a map of the optical index of the medium at each focal point;
numerically determining a second propagator based on said map of the optical index of the medium; and
   determining a second focused volumetric reflection matrix using said second propagator.

Said second propagator, whether optimized on the basis of the directly integrated index or on the basis of the sample index derived from the integrated index in order to maximize the intensity of the RPSF at the focal point, corresponds to a propagator that allows the coherence volume and geometric focal plane to coincide substantially by accounting for index inhomogeneities in the bulk scattering medium.

The resulting second focused volumetric reflection matrix can be used to establish a confocal image of the reflectivity of the medium, with the axial focusing and distortion defects of the initial confocal image corrected. A map of the RPSF associated with this second focused volumetric reflection matrix can also be used to locally quantify a multiple scattering rate for each voxel of the image. This parameter gives a local reliability index of the image and locally characterizes the scattering properties of the medium. Said map of the RPSF also allows a single scattering rate to be quantified, the depth gradient of which gives access to a local estimate of the scattering mean free path.

According to one or more exemplary embodiments, the method further comprises determining, on the basis of the second focused volumetric reflection matrix, a distortion matrix defined between a correction base and a focused base, the determination of the distortion matrix comprising:
projecting, at entrance or at exit, the second focused volumetric reflection matrix, in the correction base, to obtain a projected reflection matrix at entrance or at exit, respectively;
determining the distortion matrix via term-by-term product between said projected reflection matrix and a reference reflection matrix, defined for a reference medium, in said correction base;
locally determining the invariants of said distortion matrix, in order to identify, in the correction base, aberration laws in sub-domains of the field of view;
estimating, on the basis of said aberration laws, a transmission matrix between voxels of the field of view and the correction base.

A focused base, respectively at entrance or at exit, is the set of source points, or receiving points, conjugated to the voxels forming the sample.

Local correction of aberrations carried out in this way produces a confocal image with optimized contrast and resolution throughout the volume of the sample.

According to one or more exemplary embodiments, the distortion matrix is determined in the same way but from the first focused volumetric reflection matrix, obtained by means of the first propagator when there has been no propagator optimization step to maximize the intensity of the spread function at each focal point.

A term-by-term product between matrices is also known as a Hadamard product.

According to one or more exemplary embodiments, the reference medium is a homogeneous medium with an optical index equal to the mean index of the propagation medium. The reference reflection matrix can be established theoretically for this reference medium with a plane mirror in the focal plane of the microscope objective. Depending on the degree of prior knowledge of the propagation medium, the reference medium may take more elaborate forms (e.g. multi-layer medium, etc.). In this case, the reference matrix may be calculated numerically. To construct the distortion matrix, the phase of each element of the projected reflection matrix is subtracted from the phase of the corresponding element of the reference reflection matrix.

According to one or more exemplary embodiments, the correction base in which said distortion matrix is defined is a base maximizing the size of the isoplanatism domains contained in the field of view, for example the set of points of a plane conjugate with the plane of an aberrator if the latter is two-dimensional, or for example a plane conjugate with the pupil plane of the microscope objective.

According to one or more exemplary embodiments, local determination of the invariants of said distortion matrix comprises, as described in [Ref. 4], a singular-value decomposition of said distortion matrix, a singular-value decomposition of a normalized distortion matrix, i.e. one of which modulus of each element has been normalized but of which the phase has been preserved, a singular-value decomposition of a normalized correlation matrix of said distortion matrix, i.e. a correlation matrix of said first distortion matrix of which the modulus of each element has been normalized. Other methods are possible for the local determination of the invariants, such as an iterative phase-reversal process applied to said distortion matrix.

According to one or more exemplary embodiments, the light source is a variable-wavelength source and, for each incident light wave of given wavefront, the interference signals of the second plurality N_{ω} of interference signals are acquired for N_{ω} frequencies (or wavelengths) of said incident light wave and a fixed path difference between the object arm and the reference arm of the first interferometer. What is meant by frequency of an incident wave (or wavelength) in the present description is the central frequency (or central wavelength) of the spectrum of the incident wave.

According to one or more exemplary embodiments, for each incident light wave of predetermined wavefront, the interference signals of said second plurality of interference signals are acquired for N_{ω} path differences between the object arm and the reference arm of the first interferometer. A simple time Fourier transform operation can then be used to obtain the polychromatic reflection matrix from the interference signals acquired for different path, or time-of-flight, differences. In one or more exemplary embodiments, the polychromatic reflection matrix is generated between an emitting measurement base, which is a plane wave base (entrance pupil plane), and a receiving measurement base (detection plane). A propagator for determining a first focused volumetric reflection matrix on the basis of said polychromatic reflection matrix comprises, for example, a first, entrance base change which makes it possible to go from the entrance pupil plane to an emitting focal plane, and a second, exit base change which makes it possible to go from the detection plane to a receiving focal plane, also known as an exit focal plane. Such propagators are known to a person skilled in the art. These propagators can, for example, comprise Fresnel transform operations.

According to one or more exemplary embodiments, the Nᵢₙ incident light waves are spatially coherent and have wavefronts controlled by means for spatially shaping the wavefront.

For example, the means for spatially shaping the wavefront comprise scanning means and Nᵢₙ incident light waves are plane waves each having a wave vector with a different direction.

However, the predetermined wave fronts are not necessarily plane waves with wave vectors having different directions. For example, the illuminating device may comprise a spatial wavefront modulator, such as a deformable mirror or liquid crystal modulator, in order to generate different predetermined wavefronts.

Incident light waves are spatially coherent when the mutual coherence function of the electromagnetic field is uniform in a plane of space.

Conversely, a light wave is spatially incoherent when the mutual coherence function of the electromagnetic field has a support limited only by diffraction, i.e. of the order of half the wavelength.

In the present description, a partially spatially coherent wave is one for which the mutual coherence function has a finite support, the width of which is greater than half the wavelength.

According to one or more exemplary embodiments, said light source for emitting spatially coherent incident light waves is a spectrally scanned single-mode laser, for example a laser emitting in a spectral range between wavelengths equal to about 800 and about 875 nm.

According to one or more exemplary embodiments, said light source is a low spatial coherence source, the method further comprising:
generating, on the basis of each spatially incoherent or partially coherent light wave from the light source, by means of a second interferometer, two polarized illumination waves with orthogonal polarizations and having a spatial shift in a plane conjugate with a focal plane of the first microscope objective;
varying said spatial shift to generate the Nᵢₙ incident waves of different wavefronts;
sending, for each spatial shift, said polarized waves with orthogonal polarizations to the object and reference arms of said first interferometer, respectively, by means of a polarization splitter element;
acquiring, by means of the detector, said second plurality of interference signals, each interference signal resulting from the interference, in the detection plane of the detector, between a wave backscattered by the sample illuminated by one of said polarized waves with orthogonal polarizations, and a reference wave generated by the reflection of the other of said polarized waves with orthogonal polarizations by a reference mirror of the reference arm, said interference signals being acquired for N_{ω} different path differences between the backscattered wave and the reference wave;
said polychromatic reflection matrix being determined on the basis of the set of the interference signals acquired for the Nᵢₙ spatial shifts and N_{ω} path differences.

Said low spatial coherence source is, for example, a light-emitting diode or a halogen lamp.

The characterization method thus described has the advantage of being faster, in terms of acquisition time, and optimal, in terms of signal-to-noise ratio, for obtaining a confocal image of one or more cross sections of the sample.

According to a second aspect, the present description relates to an optical characterization system for implementing method for the characterization of an optical sample in accordance with the first aspect.

Thus, the present description relates to a system for the optical characterization of a sample formed of a bulk scattering medium, the system comprising:
a first interferometer with an object arm and a reference arm, the object arm comprising a first microscope objective with a given field of view in which, in operation, the sample is positioned;
an illuminating device comprising a wide spectral band light source, configured to generate a first plurality of incident light waves having different wavefronts;
a detector comprising Nₒᵤₜ elementary detectors, configured to acquire, for each incident light wave of given wavefront, a second plurality of interference signals, each interference signal resulting from the interference, in a detection plane of the detector, between a wave backscattered by the sample illuminated by said incident light wave and a reference wave from the reference arm, said interference signals being acquired for N_{ω} different frequencies or N_{ω} different path differences between the backscattered wave and the reference wave;
a processing unit configured to:
   determine a three-dimensional polychromatic reflection matrix \tilde{R}_{ρu}=[\tilde{R}(ρₒᵤₜ, uᵢₙ, ω)] of size Nᵢₙ×Nₒᵤₜ×N_{ω}, said three-dimensional polychromatic reflection matrix comprising all of the interference signals acquired for the Nᵢₙ incident light waves and N_{ω} frequencies;
numerically determine, by applying a first propagator, on the basis of said polychromatic reflection matrix, at least a first focused volumetric reflection matrix, comprising a set of responses for the sample between source points and receiving points that are conjugate with voxels rᵢₙ(x′ᵢₙ, y′ᵢₙ, zᵢₙ) and rₒᵤₜ(x′ₒᵤₜ, y′ₒᵤₜ, Zₒᵤₜ) of the sample which are located at depths zᵢₙ and zₒᵤₜ in the sample, respectively;
determining, on the basis of said first focused volumetric reflection matrix, at least one map of a physical parameter of said sample.

According to one or more exemplary embodiments, said first interferometer is a Linnik interferometer and the reference arm comprises a reference mirror and a second microscope objective.

However, other arrangements are possible for the first interferometer, which a person skilled in the art will be able to implement with their general knowledge. In particular, the first interferometer might not comprise a reference mirror and/or microscope objective on the reference arm.

According to one or more exemplary embodiments, the detector comprises a two-dimensional acquisition device, such as a CCD or CMOS camera.

In other exemplary embodiments, the detector comprises a spectrometer. The acquisition of the interference signals for N_{ω} frequencies can then take place on detection.

According to one or more exemplary embodiments, the light source is a low spatial coherence source; and the illuminating device comprises:
a second interferometer configured to generate, on the basis of each spatially incoherent or partially coherent light wave from the light source, two polarized illumination waves with orthogonal polarizations and having a spatial shift in a plane conjugate with a focal plane of the first microscope objective; and
means for varying the spatial shift; and wherein
said first interferometer is a Linnik interferometer and comprises
a polarization splitter element configured to send, to the object and reference arms, respectively, each of said polarized waves with orthogonal polarizations and having said spatial shift;
means for varying the path difference between the reference arms; and wherein
each interference signal of said second plurality of interference signals results from the interference, in the detection plane of the detector, between a wave backscattered by the sample illuminated by one of said polarized waves with orthogonal polarizations, and a reference wave generated by the reflection of the other of said polarized waves with orthogonal polarizations by a reference mirror of the reference arm, said interference signals being acquired for N_{ω} different path differences between the backscattered wave and the reference wave;
said polychromatic reflection matrix is determined on the basis of the set of the interference signals acquired for the Nᵢₙ spatial shifts and N_{ω} path differences.

### BRIEF DESCRIPTION OF THE FIGURES

Further advantages and features of the invention presented above will become apparent from the detailed description below, provided with reference to the figures in which:

FIG. 1A shows a first example of a system for the optical characterization of a bulk scattering medium according to the present description;

FIG. 1B shows a diagram illustrating the different notations used for the bases in which the matrices are described in characterization methods according to the present description;

FIG. 2A shows a diagram illustrating the scanning by Nᵢₙ light pulses of the entrance pupil of a microscope objective arranged on both the reference arm and object arm of a first interferometer in one example of a characterization system as illustrated in FIG. 1A;

FIG. 2B shows a diagram illustrating the intensity distribution of an interference signal on a detection face of a characterization system as shown in FIG. 1A;

FIG. 2C shows a representation of an example of a polychromatic reflection matrix comprising all of the interference signals acquired for Nᵢₙ incident light waves and N_{ω} wavelengths, said matrix being obtained by means of a characterization method according to the present description;

FIG. 3A shows a diagram illustrating the response of the medium between a source point of an entrance focal base and a receiving point of an exit focused base, to illustrate an element of an example of a focused volumetric reflection matrix according to the present description;

FIG. 3B shows images illustrating maps of physical parameters obtained on the basis of the focused volumetric reflection matrix that is the object of the method according to the present description;

FIG. 3C shows a diagram illustrating the non-coincidence of the focal and coherence planes, resulting in degraded quality in the emitting and receiving focusing operations, for the construction of the focused volumetric matrix;

FIG. 4A shows diagrams illustrating spread functions (RPSFs) obtained with a first Fresnel propagator at focal points located in different focal planes;

FIG. 4B shows a diagram showing the change in the intensity maximum of the RPSF with depth z of the focal planes;

FIG. 5 shows images showing the effect of numerical dual focusing on a confocal image of a sample formed of a test pattern;

FIG. 6 shows a quantitative study of the RPSF measured in a sample formed of a cornea, in a characterization method according to the present description;

FIG. 7A shows a diagram illustrating the subdivision of the field of view performed to extract the local RPSFs;

FIG. 7B shows an image illustrating a map of the multiple scattering rate at depth z=250 μm in the sample formed of a cornea;

FIG. 7C shows an image illustrating a map of the local RPSFs at depth z=250 μm in the sample formed of a cornea;

FIG. 7D shows images showing two longitudinal sections (B-scans) of the optical index n(x,y,z) estimated in the sample formed of a cornea by means of a characterization method according to the present description;

FIG. 8 shows images illustrating the result of a method for numerically correcting transverse aberrations in the sample formed of a cornea at depth z=250 μm, by means of a characterization method according to the present description;

FIG. 9 illustrates the phase of a transmission matrix by means of an iterative aberration correction process in an exemplary method according to the present description and confocal images of the sample formed of a cornea at a depth z=250 μm, and B-scans, before and after numerical aberration correction;

FIG. 10A shows another example of a system for the optical characterization of a scattering bulk medium according to the present description, in which the first interferometer is an interferometer other than a Linnik interferometer;

FIG. 10B shows another example of a system for the optical characterization of a bulk scattering medium according to the present description, similar to that of FIG. 10A but using a spectrometer detector;

FIG. 11 shows another example of a system for the optical characterization of a bulk scattering medium according to the present description, for implementing an exemplary method according to the present description in which a polychromatic reflection matrix in the time domain and in a focused base is recorded.

In the various embodiments that will be described with reference to the figures, similar or identical elements bear the same references.

### DETAILED DESCRIPTION

In the following detailed description, only certain embodiments are described in detail in order to ensure clarity of disclosure, but these examples are not intended to limit the general scope of the principles underlying the present description.

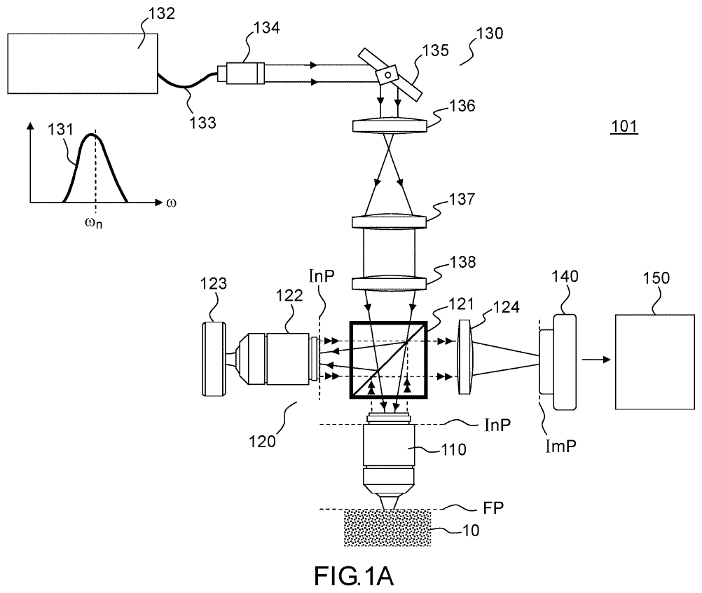

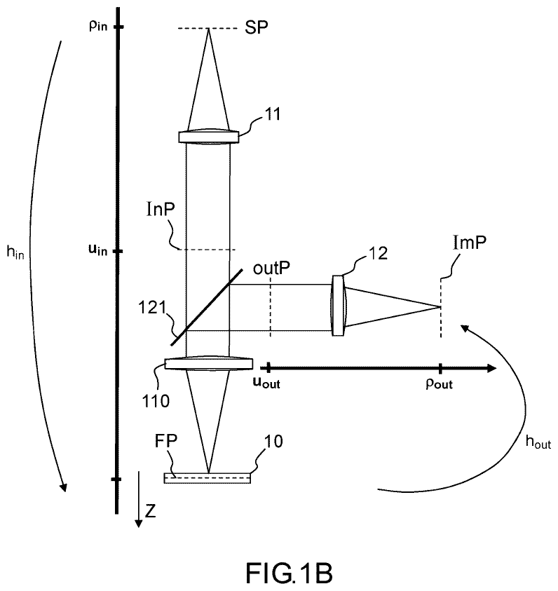

The various embodiments and aspects described in this description can be combined or simplified in many ways. In particular, the steps of the various methods can be repeated, interchanged or run in parallel, unless specified to the contrary. In the present description, whenever reference is made to calculation or processing steps for the implementation of method steps in particular, it is understood that each calculation or processing step can be implemented by software, hardware, firmware, microcode or any appropriate combination of these technologies. When software is used, each calculation or processing step can be implemented by computer program instructions or software code. These instructions can be stored in or transmitted to a computer-readable storage medium (or computing unit) and/or executed by a computer (or computing unit) in order to implement these calculation or processing steps. FIG. 1A illustrates a first example of a system 101 for the optical characterization of a sample 10 consisting of a bulk scattering medium, the system 101 being configured to implement optical characterization methods according to the present description. FIG. 1B shows a simplified diagram illustrating the bases in which the matrices are described in characterization methods according to the present description.

The system 101 comprises an illuminating device 130 with a wide spectral band light source 132, for example a spectrally scanned source configured to emit a light beam that has a frequency ω (or wavelength λ) that can vary over a spectral band [ωₘᵢₙ, ωₘₐₓ] (or wavelength range [λₘᵢₙ, λₘₐₓ]), around a central frequency ωₙ (or wavelength λₙ) as illustrated schematically in the spectrum 131. The light source 132 emits, for example, in the near infrared, for example between around λₘᵢₙ=800 nm and around λₘₐₓ=875 nm, and can scan the spectrum between these two wavelengths at a given speed, for example between around 10² nm/s and around 10⁵ nm/s. The light source is, for example, a fiber-based source, and the illuminating device can comprise an exit fiber 133 connected to a collimator 134 configured to emit a substantially collimated, spatially coherent beam.

The system 101 further comprises an interferometer 120 with an object arm and a reference arm separated by a cube splitter 121. The system 101 comprises a first microscope objective 110 arranged in the object arm of the interferometer, the sample being positioned, in operation, in a field of view of the microscope objective.

In the example shown in FIG. 1A, the interferometer 120 is a Linnik interferometer comprising, in addition to the first objective 110 on the object arm, a second microscope objective 122 arranged in the reference arm. In this example, the reference arm further comprises a reference mirror 123.

As illustrated in FIG. 1A, the light-emitting device also comprises, in this example, means 135 for scanning the collimated beam and a set of lenses 136, 137, 138. The lenses 137 and 138, referred to as the scan lens and tube lens, respectively, form a 4f assembly of given magnification, while the lens 138 is configured to focus the beam exiting the 4f assembly in a plane InP corresponding to a plane of an entrance pupil of the microscope objective 110 (“entrance pupil plane ”). The scanning means 135 comprise, for example, two scanning mirrors rotated by galvanometric motors in order to scan the incident light beam (represented by single-headed arrows in FIG. 1A) in the entrance pupil plane InP of the microscope objective 110 arranged on the object arm of the interferometer 120, in both spatial directions. It should be noted that in the example of FIG. 1A, because a Linnik interferometer is used, the incident beam also scans the entrance pupil plane of the second microscope objective 122 arranged on the reference arm of the interferometer.

The system 101 further comprises a detector 140 with a detection plane ImP and a processing unit 150 configured to process the data generated by the detector, as will be explained later. The detector comprises, for example, a camera configured to acquire two-dimensional images at a given acquisition frequency. For example, the camera allows the acquisition of 256×256 pixel images at a given frequency, e.g. around 75 kHz.

Of course, other configurations are possible for the optical characterization system 101, which a person skilled in the art will be able to implement using their general knowledge in the field. For example, the system 101 can be deployed in a polarized configuration. In this case, the cube splitter is a polarizing cube splitter. Two quarter-wave plates can be placed between the microscope objectives and the cube splitter. Upstream of the detector 140, a polarization analyzer can be arranged in order to recombine the two polarizations.

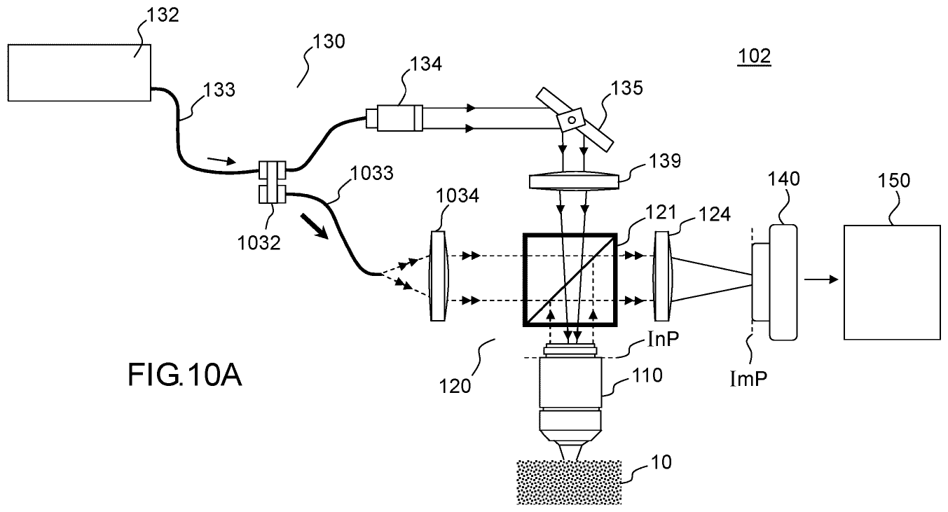

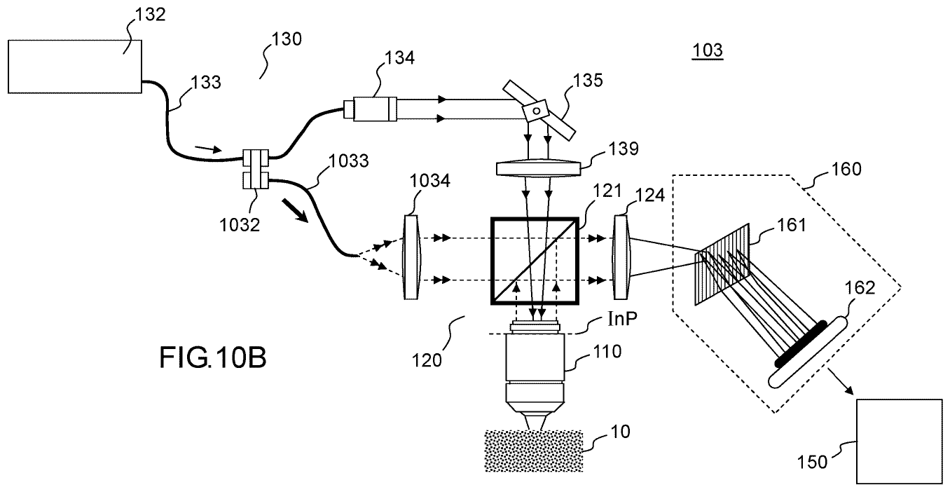

In addition, the wide band source is not necessarily variable-frequency. It is possible, for example, to replace the camera with a spectrometer, as will be described by means of FIG. 10B, with frequency selection taking place on detection.

Additionally, instead of varying the frequency of the source, it is equivalently possible to vary the path difference (or “time of flight”) between the object and reference arms of the interferometer, for example by moving the block consisting of the reference mirror 123 and the second microscope objective 122.

Other interferometric arrangements are also possible instead of the Linnik interferometer. For example, as will be described with reference to FIG. 10A, the reference wave in the interferometer can come directly from the source.

The notations used in the present description to identify the various bases in which are described, in particular, the reflection matrices for characterization of the sample are given in FIG. 1B. For the sake of simplicity, FIG. 1B illustrates just a few of the elements of the characterization system. The notations apply to the setup of FIG. 1A but also, more generally, to all of the characterization systems of the present description.

The focal plane of the microscope objective 110 is denoted by FP and is intended to receive the sample 10. InP is used to denote the plane of the entrance pupil of the microscope objective, or any plane conjugate with the plane of the entrance pupil of the microscope objective, and it is referred to as the entrance plane wave base. The entrance pupil is intended to receive the incident light waves for illuminating a field of view of the sample to be characterized. The notation uᵢₙ denotes a point in the plane of the entrance pupil InP, defined by its Cartesian coordinates (vᵢₙ, wᵢₙ). OutP is used to denote the plane of the exit pupil of the microscope objective, or any plane conjugate with the plane of the exit pupil of the microscope objective, and it is referred to as the exit plane wave base. The exit pupil is intended to receive the light waves reflected by the field of view of the sample to be characterized. The notation uₒᵤₜ denotes a point in the plane of the exit pupil OutP, defined by its Cartesian coordinates (vₒᵤₜ, wₒᵤₜ). As illustrated in FIG. 1B, the entrance and exit paths comprising the entrance and exit pupils, respectively, are separated by the beam splitter element 121. In the entrance path, SP denotes the source plane of the optical system, conjugate with the focal plane of the microscope objective, in this example represented by an lens 11 forming a 4f assembly with the microscope objective 110. The notation ρᵢₙ denotes a point in the source plane SP, defined by its Cartesian coordinates (xᵢₙ, yᵢₙ). In the exit path, ImP denotes the image plane of the optical system, conjugate with the focal plane of the microscope objective, in this example represented by an lens 12 forming a 4f assembly with the microscope objective 110. The notation ρₒᵤₜ denotes a point in the image plane ImP, defined by its Cartesian coordinates (xₒᵤₜ, yₒᵤₜ).

A voxel rᵢₙ of the sample has the coordinates (ρ′ᵢₙ, Zᵢₙ), where the transverse coordinate ρ′ᵢₙ(x′ᵢₙ, y′ᵢₙ) of the point rᵢₙ is conjugate with a point ρᵢₙ in the source plane SP. The (volumetric) base of the conjugate source points of the voxels rᵢₙ is called the entrance focal base.

A voxel rₒᵤₜ of the sample has the coordinates (ρ′ₒᵤₜ, zₒᵤₜ), where the transverse coordinate ρ′ₒᵤₜ(x′ₒᵤₜ, y′ₒᵤₜ) of the point rₒᵤₜ is conjugate with a point ρₒᵤₜ of the image plane ImP. The (volumetric) base of the conjugate receiving points of the voxels rₒᵤₜ is called the entrance focal base. In operation, the illuminating device 130 allows the characterization method to be implemented according to an example in accordance with the present description, as follows. For a given frequency (or length), the illuminating device generates a first plurality of Nᵢₙ incident light waves consisting of different predetermined wavefronts. For example, as illustrated in FIG. 1A, the Nᵢₙ incident light waves are Nᵢₙ plane waves with wave vectors of different directions controlled by the scanning means 135. For example, a lens 124 (exit lens) ensures optical conjugation between the object focal plane FP of the microscope objective 110 and the detection plane ImP of the detector 140. Thus, according to one example, in operation, the scanning means 135 cooperate with the 4f assembly 136, 137 and the focusing lens 138 in order to scan, in both spatial directions, the pupil plane InP of the microscope objectives 110 and 122 arranged on the object arm and reference arm, respectively, of the Linnik interferometer 120. The Nᵢₙ incident light waves thus generated each have a wave vectorₖᵢₙ, the direction and norm of which depend in particular on the scanning angle dictated by the scanning means 135 and the frequency ω (or wavelength λ) of the incident wave.

Furthermore, for each incident light wave of predetermined wavefront, the detector 140 acquires a second plurality of N_{ω} interference signals, each interference signal resulting from the interference, in a detection plane ImP of the detector, between a wave backscattered by the sample 10 illuminated by said incident light wave and a reference wave from the reference arm, the N_{ω} interference signals being acquired for N_{ω} different frequencies. For example, in the example of FIG. 1A in which the illuminating device 130 comprises a spectrally scanned light source, the N_{ω} interference signals are acquired by varying the wavelength of the light source.

The fields backscattered by the two arms of the interferometer interfere at the detection plane ImP of the detector 140. The interference term between the two arms for a frequency ω of the incident wave corresponds to the product between the field reflected by the sample Eₛ and the phase conjugate Eᵣ* of the reference field from the reference arm according to equation:

$$\text{?} ( {ρ}_{out} , {u}_{in} , ω ) = \text{?} ( {ρ}_{out} , {u}_{in} , ω ) \times \text{?} ( {ρ}_{out} , {u}_{in} , ω ) \qquad [ Math 2 ]$$

$$\text{?} \text{indicates text missing or illegible when filed}$$

Where ρₒᵤₜ(xₒᵤₜ, yₒᵤₜ) is a vector of spatial coordinates (xₒᵤₜ, yₒᵤₜ) in the detection plane ImP (receiving measurement plane) and uᵢₙ(vᵢₙ, wᵢₙ) is a vector of spatial coordinates (vᵢₙ, wᵢₙ) in the pupil plane InP of the microscope objective 110 (emitting measurement plane).

In operation, the lens 138 allows the incident beam to be focused in the pupil plane of the microscope objectives. The associated focal spot, of dimension δu, is limited only by diffraction (numerical aperture of the system upstream of the interferometer). This focal spot is converted by the microscope objective into a quasi-planar wave illuminating the sample over a wide field of view. The latter will be imaged, in part, on the detection plane ImP.

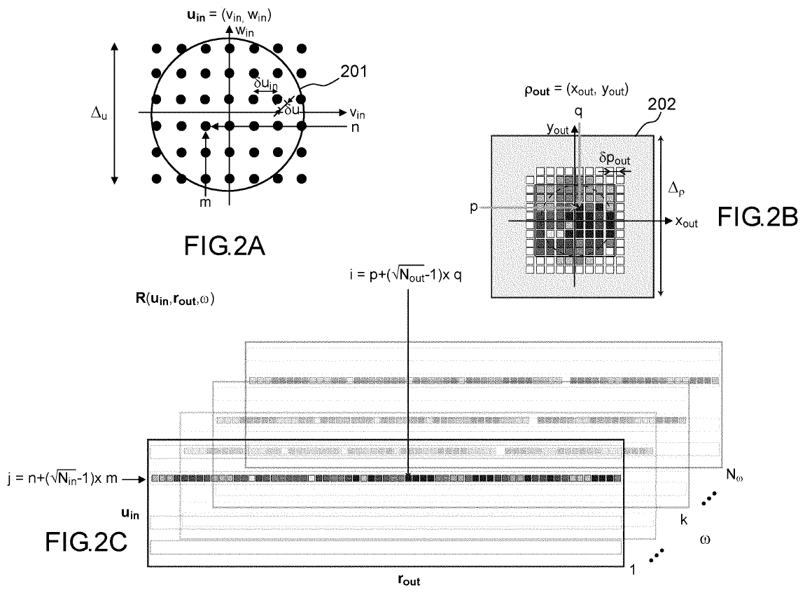

By way of illustration, FIG. 2A shows the scanning of the entrance pupil InP of the microscope objectives 110, 122 by Nᵢₙ incident light beams. The scan mirrors 135 allow the physical pupil of the microscope objectives to be scanned, the circumference of which pupil is represented by a black circle 201 in FIG. 2A. The black disks indicate the positions of each of the incident beams focused on the entrance pupil InP of the microscope objectives 110, 122. The spatial pitch between each beam is denoted by δuᵢₙ. Taking the characteristics of the microscope objectives used into account, the characteristic dimension of each focal spot is, for example, δu=8 μm. This corresponds to a maximum illumination of the field of view of Δr=λf/δu=2 mm, where f is the focal length of microscope objective 110. The spatial pitch, δuᵢₙ, corresponds to the sampling of the electromagnetic field in the emitting pupil plane, and indicates the accuracy with which incident wavefronts will be resolved when they are numerically resynthesized using the measured reflection matrix. This spatial pitch can therefore advantageously be adjusted according to the level of aberrations generated by the medium; it can be chosen to be fine enough to capture the fastest spatial fluctuations in the distortions experienced by the light wave as it passes through the medium. Depending on the intended application, the entire entrance pupil 201 or just a sub-section of it can be scanned. For example, to be able to obtain a highly resolved confocal image, the entire entrance pupil can be scanned, as shown in FIG. 2A.

For each illumination of the sample, the interference term \tilde{R}(ρₒᵤₜ, uᵢₙ, ω) is measured by a detector in the detection plane ImP.

FIG. 2B illustrates the field of view Δp in the detection plane of the camera and the spatial sampling δρₒᵤₜ under which each interference signal (or interferogram) is recorded. The notation Nₒᵤₜ denotes the number of pixels (or elementary detectors) of the camera over which the interference signal is acquired. The field of view corresponds to a magnified image of the focal plane of the microscope objective by a factor G, G being the magnification of an imaging system consisting of the microscope objective and the exit lens 124. In the example system shown in FIG. 1A, G=−fₛ/fₒₘ, where fₛ and fₒₘ are the focal lengths of the lenses 124 and of the microscope objectives 110 and 122.

All of the interferograms recorded for each illumination uᵢₙ and each frequency a> are stored as a 3D polychromatic reflection matrix, \tilde{R}_{ρu}=[\tilde{R}(ρₒᵤₜ, uᵢₙ, ω)], de taille Nₒᵤₜ×Nᵢₙ×N_{ω}.

FIG. 2C illustrates, according to one example, such a 3D polychromatic reflection matrix in order to show its three-dimensional structure. The first dimension designates the detection point pout in the detection plane of the camera, the coordinates (xₒᵤₜ, yₒᵤₜ) of which are given by the index i=p+(\sqrt{Nₒᵤₜ}−1)×q. With p=(\sqrt{Nₒᵤₜ}+1)/2+(xₒᵤₜ/δρₒᵤₜ) and q=[(\sqrt{Nₒᵤₜ}+1)/2+(yₒᵤₜ/δρₒᵤₜ)]. The second dimension designates the coordinate uᵢₙ of each incident beam focused in the entrance pupil plane InP. The coordinates (vᵢₙ, wᵢₙ) of uᵢₙ are marked by the index j=n+(\sqrt{Nᵢₙ}−1)×m. Where n=(\sqrt{Nᵢₙ}+1)/2+(vᵢₙ/δuᵢₙ) et m=[\sqrt{Nᵢₙ}+1)/2+(yᵢₙ/δuᵢₙ)].

The third dimension, marked by the index k, corresponds to the set of frequencies ω at which the interference signal is recorded.

A theoretical total acquisition time for the matrix \tilde{R}_{ρu}=[\tilde{R}(ρₒᵤₜ, uᵢₙ, ω)] can therefore be estimated, in this example, with t_{acq}=Nᵢₙtₛ, and tₛ=N_{ω}/ƒ_{c} corresponding to the acquisition time for an image of the volume of interest for a single illumination and fc being the acquisition frequency of the camera. The number N_{ω} of frequencies (or wavelengths) is adjusted according to the thickness L of the medium to be imaged. Specifically, N_{ω}=δω/δω, with Δω=ωₘₐₓ−ωₘᵢₙ is the bandwidth over which \tilde{R}_{ρu} is measured and δω is the frequency sampling dictated by the thickness L of the medium to be imaged, such that δω=c₀/(2n̅L) where it is the mean optical index of the sample and c₀ is the speed of light. By way of example, for Nᵢₙ=11² incident plane waves, L=500 μm, and f_{c}=100 kHz, the acquisition time for an image of the volume of interest is tₛ=1 ms and the total acquisition time for the matrix \tilde{R}_{ρu} is t_{acq}=121 ms.

A second step of the method according to the present description comprises the numerical determination, by applying a propagator and on the basis of said polychromatic reflection matrix \tilde{R}_{ρu}, of at least a first focused volumetric reflection matrix \tilde{R}ᵣᵣ32 [R(rₒᵤₜ, rᵢₙ, ω)]. The focused volumetric reflection matrix comprises a set of responses for the sample between source points and receiving points conjugated with voxels of the bulk medium 10. A response of the sample at a given frequency between a source point and a detection point is the reflection coefficient of the sample, measured at the detection point when a light wave at said frequency is emitted from the source point. The position of the voxels is identified by the vectors rᵢₙ=(x′ᵢₙ,y,ᵢₙ, zᵢₙ) for emitting and rₒᵤₜ=(x′ₒᵤₜ,y′ₒᵤₜ, zₒᵤₜ) for receiving. A voxel is defined as a volumetric cell of given resolution. For example, the dimensions of such a volumetric resolution cell are determined, in the example of a system as shown in FIG. 1A, by the transverse resolution of the device along (x, y) and the depth of field or spectral band of the source along z. Unlike in the prior art [Ref.4], the voxels can be located at different depths in the medium, as explained below. The depth z in the bulk medium 10 is defined along an axis (z) parallel to the optical axis of the microscope objective, for example with respect to an origin z_{ref}=0, which corresponds to the zero path difference between the reference and sample arms.

The numerical determination of the focused volumetric reflection matrix \tilde{R}ᵣᵣ on the basis of the polychromatic reflection matrix \tilde{R}_{ρu} comprises, in this example, a first, entrance base change which makes it possible to go from the entrance pupil plane to the emitting focused base (entrance focused base), and a second, exit base change which makes it possible to go from the detection plane to a receiving focused base (exit focused base). In the remainder of the description, these base changes are referred to as the emitting and receiving numerical focusing operation, or the dual focusing operation.

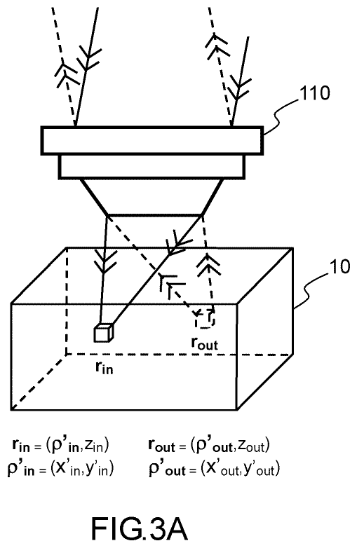

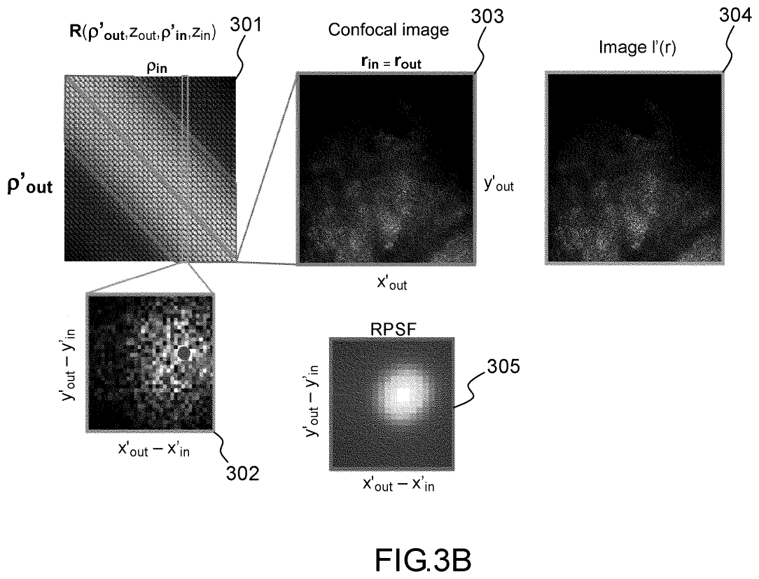

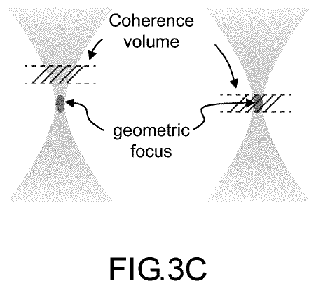

FIG. 3A illustrates the numerical focusing procedure on two voxels located at points rᵢₙ and rₒᵤₜ located at distinct depths (zᵢₙ and zₒᵤₜ, respectively) in the medium being studied.

To carry out the transition from the polychromatic reflection matrix \tilde{R}_{ρu} to the focused bulk matrix \tilde{R}ᵣᵣ, the emitting and receiving dual focusing operation is carried out using, for example, a Fresnel propagator. To this end, the polychromatic reflection matrix \tilde{R}_{ρu}=[\tilde{R}(ρₒᵤₜ, uᵢₙ, ω)] can first be projected at exit in a virtual Fourier plane (u′ₒᵤₜ) via a simple spatial Fourier transform on the exit coordinate ρₒᵤₜ:

$$\text{?} ( {u}_{out}^{′} , {u}_{in} , ω ) = \frac{1}{{N}_{out}} \text{?} ( {ρ}_{out} , {u}_{in} , ω ) \text{?} \qquad [ Math 3 ]$$

$$\text{?} \text{indicates text missing or illegible when filed}$$

Fresnel masks, denoted by F(u, zᵢₙ/ₒᵤₜ−Z_{f}, ω), are then applied to the entrance and exit of the resulting matrix \tilde{R}ᵤᵤ=[\tilde{R}(u′ₒᵤₜ, uᵢₙ, ω)] in order to numerically translate the emitting and receiving focal planes, initially located at depth z_{f}, to a depth zᵢₙ, or zₒᵤₜ in the sample, where z_{f} is the focal length of the microscope objective 110:

$${\tilde{R}}^{′} ( {u}_{out}^{′} , {z}_{out} , {u}_{in} , {z}_{in} , ω ) = \text{?} ( {u}_{out}^{′} - {u}_{in} , {z}_{out} - {z}_{f} , ω ) \text{?} ( {u}_{out}^{′} , {u}_{in} , ω ) F ( {u}_{in} , {z}_{in} - {z}_{f} , ω ) \qquad [ Math 4 ]$$

$$\text{?} \text{indicates text missing or illegible when filed}$$

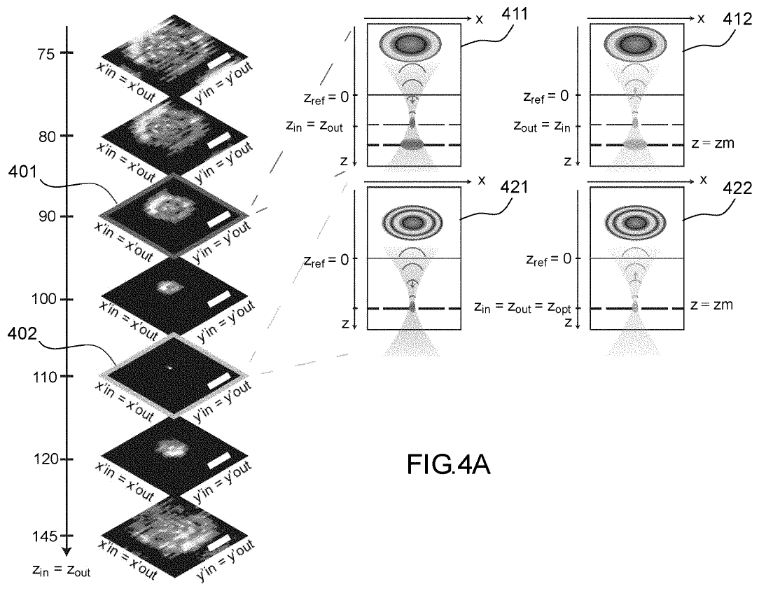

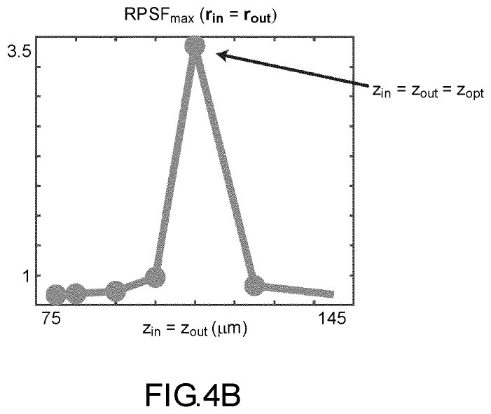

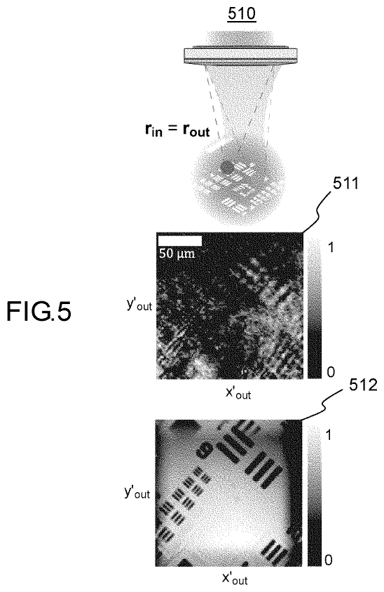

Examples of Fresnel masks F, 411, 421, are shown in FIG. 4A for different focusing depths z=zᵢₙ=zₒᵤₜ. This is expressed as follows:

$$F ( u , z , ω ) = \text{?} \qquad [ Math 5 ]$$

$$\text{?} \text{indicates text missing or illegible when filed}$$

where n̅ is the assumed optical index of the medium being studied, considered for the moment to be homogeneous and

$${k}_{z} = \frac{2 π}{λ} \sqrt{\text{?} - \frac{\text{?}}{{f}^{2}}} \text{?}$$

$$\text{?} \text{indicates text missing or illegible when filed}$$

is the axial wave number. An inverse spatial Fourier transform can be applied to the coordinates u′ₒᵤₜ and uᵢₙ in order to project the incident and reflected fields into the focused bases rₒᵤₜ and rᵢₙ and thus obtain the focused volumetric reflection matrix \tilde{R}ᵣᵣ=[R(rₒᵤₜ, rᵢₙ, ω)].

A numerical Fourier transform on the frequencies ω applied to the polychromatic focused reflection matrix \tilde{R}ᵣᵣ is then used to discriminate the scattered photons according to their time of flight in the sample. The resulting matrix is denoted by Rᵣᵣ=[R(rₒᵤₜ, rᵢₙ, t)]. Ideally, i.e. under the single scattering approximation and for a medium of homogeneous index n̅, each time of flight is associated with photons scattered at depth z=c₀t/(2n̅) in the sample.

To illustrate the value of the focused volumetric reflection matrix Rᵣᵣ, the applicants measured the polychromatic matrix \tilde{R}_{ρu} using a system as described in FIG. 1A on an opaque human cornea of thickness L=400 μm and of mean index n̅=1.4. The numerical aperture of the microscope objectives is ON=0.3. The acquisition parameters are as follows: Nᵢₙ=441, N_{ω}=80, λₘᵢₙ=800 nm, λₘₐₓ=875 nm, field of view in the object focal plane of the microscope objective 716×716 μm.

FIG. 3B illustrates, according to one example, a sub-section 301 (or cross section) of the matrix Rᵣᵣ=[R(rₒᵤₜ, rᵢₙ, t)] constructed from \tilde{R}_{ρu}, for z=zᵢₙ=zₒᵤₜ=250 μm and ballistic time t=2n̅z/c₀ and a column 302 of this sub-matrix rearranged in two-dimensional form.

Each column 302 of the sub-section 302 of the matrix Rᵣᵣ gives the reflected field measured by each virtual receiving point rₒᵤₜ for a light wave emitted from the virtual source point rᵢₙ. In an ideal case with no aberrations or multiple scattering, an Airy disk would be observed around the source point rᵢₙ. Here, however, the reflected field takes the form of a diffuse halo around point rᵢₙ, indicating that the assumption made about the optical index is not necessarily optimal, as will be described in greater detail later on.

Nevertheless, the wide band focused matrix Rᵣᵣ provides access to a set of relevant observables which will now be exploited in order to quantitatively characterize the sample being studied.

First, a time-windowed confocal image ℑ(r) can be constructed by considering the following elements of the matrix Rᵣᵣ:

$$𝒥 ( r ) = R ( r , r , t = 2 \text{?} z / {c}_{0} ) \qquad [ Math 6 ]$$

$$\text{?} \text{indicates text missing or illegible when filed}$$

FIG. 3B thus shows the confocal image 303 of the cornea for z=250 μm. The latter corresponds to the diagonal elements of the sub-matrix 302 after being rearranged in two-dimensional form. The confocal image ℑ(r) is an estimator of the reflectivity of the cornea in a coherence plane associated with singly scattered photons, the time of flight of which is given by t=2n̅z/c₀.

The quality of this estimator depends on the quality of focusing in the medium. The expression hᵢₙ/ₒᵤₜ(r,rᵢₙ/ₒᵤₜ) denotes the impulse response between each point rᵢₙ/ₒᵤₜ and each point r in the sample (see FIG. 1B). To quantify focusing quality, a relevant observable is the reflection point spread function (RPSF) around the reflection focal point, which can be accessed by measuring the distribution of backscattered energy along the antidiagonals of the sub-matrix Rᵣᵣ (z, t), which assumes identical entrance and exit focal planes (zᵢₙ=zₒᵤₜ):

$$[ Math 7 ]$$

$${RPSF ( {r}_{p} , Δ x , Δ y , t ) = 〈 \vert R ( \{ {x}_{p} - Δ x / 2 , {y}_{p} - Δ y / 2 , {z}_{p} \} , \{ {x}_{p} + Δ x / 2 , {y}_{p} + Δ y / 2 , {z}_{p} ] , t ) \vert}^{2} 〉$$

where < . . . > is a mean over the pairs of points rᵢₙ and rₒᵤₜ centered on the same point rₚ such that rₚ=(rᵢₙ+rₒᵤₜ)/2. Δr=rₒᵤₜ−rᵢₙ is the relative position between these two points (coordinates Δx, Δy). This intensity profile is relevant because it allows aberrations to be probed independently of the local reflectivity of the medium. Specifically, by considering the entrance and exit PSFs as locally isoplanatic, it is possible to redefine invariant local PSFs

$$\text{?}$$

$$\text{?} \text{indicates text missing or illegible when filed}$$

by translation around each point rₚ, such that

$${h}_{in} {/}_{out} ( r , {r}_{in} {/}_{out} ) = \text{?} ( r - {r}_{in / out} , {r}_{p} ) .$$

$$\text{?} \text{indicates text missing or illegible when filed}$$

Under this assumption and for a medium of random reflectivity, the RPSF gives the convolution product between the incoherent entrance and exit spread functions of the imaging device:

$$[ Math 8 ]$$

$$RPSF ( {r}_{p} , Δ x , Δ y , t ) ∝ {\vert \text{?} ( \{ Δ x , Δ y , 0 \} , {r}_{p} ) \vert}^{2} {⊗}_{Δ x , Δ y} {\vert {h}_{out} ( \{ Δ x , Δ y , 0 \} , {r}_{p} ) \vert}^{2}$$

$$\text{?} \text{indicates text missing or illegible when filed}$$

For a specular object, the RPSF gives access to the convolution product between the coherent entrance and exit spread functions:

$$[ Math 9 ]$$

$$RPSF ( {r}_{p} , Δ x , Δ y , t ) ∝ {\vert \text{?} ( \{ Δ x , Δ y , 0 \} , {r}_{p} ) {⊗}_{Δ x , Δ y} \text{?} ( \{ Δ x , Δ y , 0 \} , {r}_{p} ) \vert}^{2}$$

$$\text{?} \text{indicates text missing or illegible when filed}$$

In these two asymptotic regimes, the RPSF does not probe exactly the same physical quantity, but its spatial distribution is indicative of the local level of aberration at the point rₚ. FIG. 3B shows the RPSF 305 obtained in the opaque cornea at a depth zₚ=250 μm. This has the following appearance: an overintensity associated with photons scattered by the coherence plane and an incoherent background associated with multiple scattering events taking place upstream of this same plane. The position of the maximum of the RPSF and the spatial extension of the overintensity observed on the RPSF gives information on the focusing quality.

FIG. 3B shows that the maximum of the RPSF (305) is not centered at Δr=0. This is due in particular to an alignment problem with the first interferometer. The confocal intensity therefore corresponds not to the relative position Δr=0 but to the position Δrₘₐₓ of the intensity maximum of the RPSF. A new confocal image ℑ′(r) corrected for these alignment problems can thus be produced:

$$( r ) = R ( r , r + Δ {r}_{max} , t = 2 \overline{n} z / {c}_{0} ) . \qquad [ Math 10 ]$$

Image 304 shows the new confocal image obtained. Comparison with the raw confocal image ℑ(r) 303 shows that a first use of the RPSF is that of making it possible to overcome alignment problems in the device.

Additionally, if, apart from these alignment problems, the numerical focusing process were ideal, RPSF support would extend to a single resolution cell. As explained above, FIG. 3B shows that this is not the case with the opaque cornea being studied.

FIG. 3C illustrates the main reason for this poor focusing quality: the non-coincidence of the focal and coherence planes. The finite depth of field of the microscope objectives can lead to focusing defects both for emitting and receiving.

FIG. 4A shows how the RPSF can be used to adjust the position of the coherence and focal planes. This figure is based on a proof-of-concept experiment on a test pattern defocused by a distance of zₘ=100 μm under the focal plane of the microscope objective of the sample arm (ON=0.3). FIG. 4A shows the RPSFs obtained for different focal planes z=zᵢₙ=zₒᵤₜ and for a coherence plane coincident with the position of the test pattern: t=2zₘ/c₀.

When z<zₘ (or, equivalently, for z>zₘ), the spread of the RPSF (411, 412) is characteristic of a focusing defect. An estimator is then defined in order to determine the value of zₘ. This estimator corresponds to the position zₒₚₜ that maximizes the confocal intensity, i.e. the maximum of the RPSF, denoted by RPSFmax. For z=zₒₚₜ, FIG. 4A (421, 422) clearly shows that the transverse extension of RPSF is minimal, i.e. only limited by diffraction.

FIG. 4B shows the change in RPSFₘₐₓ with depth z. It is indeed found that zₒₚₜ=zₘ and the confocal intensity is 3.5 times more intense than outside the depth of field (|z−zₘ|>20 μm). FIG. 3C summarizes the numerical focusing optimization process. By maximizing the confocal intensity (RPSFₘₐₓ), it is possible to make the coherence plane, corresponding to the interferometric nature of the measurement, coincide with the geometric focus linked to the position of the sample in relation to the microscope objective. FIG. 5 shows the effect of the numerical dual focusing on a confocal image of the test pattern (510). Whereas the initial image 511 is degraded by the focusing defect, the numerical focusing process at entrance and exit yields an image of the test pattern 512 with optimal contrast and confocal resolution only limited by diffraction (δp ˜λ/(4NA)). After correction, all of the details of the test pattern are sharp and contrasty. A technical effect of the method described above is thus observed for producing a confocal image from a full-field spectral OCT device. It is thus possible to determine a reflectivity map of the sample on the basis of the first focused volumetric reflection matrix.

A similar focusing optimization method is applied to the reflection matrix measured in the cornea. However, in the experiment in question, the cornea is immersed in water of known index n_{water}. Most importantly, the cornea has a spatially inhomogeneous optical index n(r). First, it is assumed that the mean index of the medium is invariant with respect to lateral translation and that its optical index n depends only on depth z: n(r)=n(z). The first step in the method is to bring the focal plane, initially located at depth z_{f} in the absence of a sample, to the surface of the sample located at depth z₀ by applying the propagator F(., z₀−z_{ƒ}, ω) for an index n=n_{water} to the matrix \tilde{R}ᵤᵤ:

$${\tilde{R}}^{′} ( {u}_{out}^{′} , {z}_{0} , {u}_{in} , {z}_{0} , ω ) = F \text{} ( {u}_{out}^{′} - \text{} {u}_{in} , \text{} {z}_{0} - \text{} {z}_{f} , \text{} ω ) \text{} \tilde{R} \text{} ( \text{} {u}_{out}^{′} , \text{} {u}_{in} , \text{} ω ) \text{} F \text{} ( \text{} {u}_{in} , \text{} {z}_{0} - \text{} {z}_{f} , ω ) \qquad [ Math 11 ]$$

An estimator \hat{n}(z) of the profile of the optical index n(z) is then obtained as follows: for each time of flight t, the RPSF is scanned by modifying the mean optical index n̅, and consequently the position of the coherence plane z(n̅)=c₀t/(2n̅), in the propagator F ([Math 5]) so as to maximize the confocal intensity (RPSFₘₐₓ). The value of n maximizing this quantity gives an estimate of the integrated optical index nᵢₙₜ(z) at depth z=c₀t/(2nᵢₙₜ). The integrated index profile nᵢₙₜ(z) is defined as the integral from the surface of the medium (z=z₀) to the depth z of the optical index n(z) of the medium:

$${n}_{int} ( z ) = \frac{1}{z - {z}_{0}} {{\int }_{z0}}^{z} n ( z ) dz \qquad [ Math 12 ]$$

By discretizing this equation with respect to the time of flight t, it is then possible to deduce from the estimator \hat{n}ᵢₙₜ(z) of the integrated index profile nᵢₙₜ(z) an estimator \hat{n}(z) of the local optical index n(z) by inverting a system of linear equations.

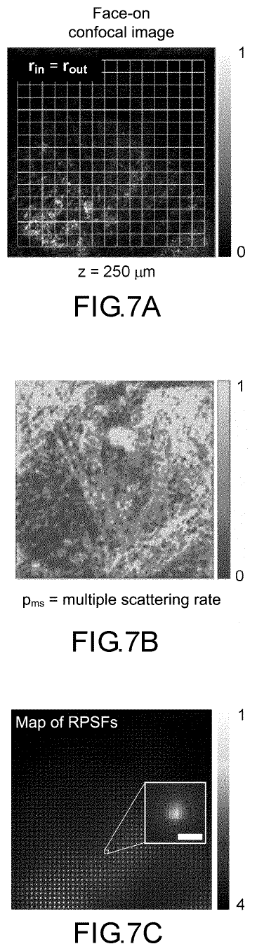

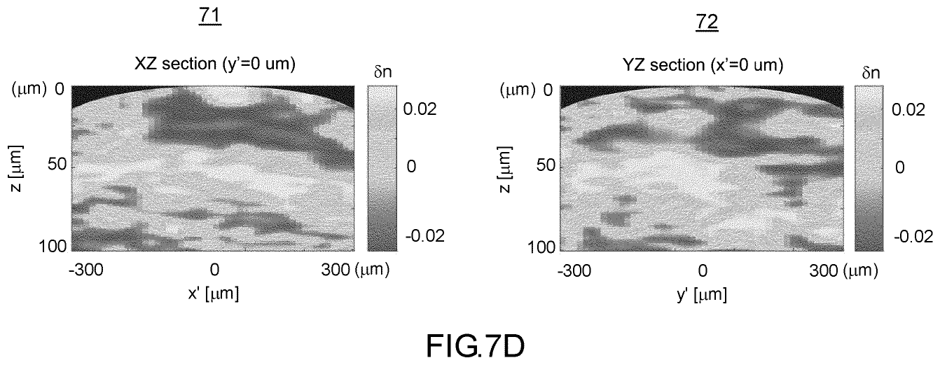

In order to obtain the dependency of n with respect to the transverse coordinates (x, y), segmentation of the field of view (see FIG. 7A) can first be performed on the reflection matrix \tilde{R}ᵣᵣ=[R(rₒᵤₜ, rᵢₙ, ω)] and the process described above can be repeated for each sub-zone of the field of view. An estimator \hat{n}(x′, y′, z) of the spatial distribution of the optical index n(x′, y′, z) in the medium can thus be obtained by considering sub-zones of the field of view centered on each transverse coordinate (x′, y′). Two longitudinal sections (B-scans) of the estimated optical index \hat{n}(x′, y′, z) in the cornea are shown in FIG. 7D (images 71, 72). The quantity given, δn(x′, y′, z)=\hat{n}(x′, y′, z)−n̅, is the deviation from the mean optical index of the cornea, here estimated at n̅=1.4.

It should be noted that the estimator n of the spatial distribution of the optical index n (referred to simply as the “optical index map” in the present description) can be used to construct a new propagator F in order to optimally describe the propagation of light from the entrance and exit pupil planes of the device to all of the voxels of the medium being studied (i.e. the focused base). This propagator can then be used to construct a new focused reflection matrix and provide a confocal image that is much closer to the actual reflectivity of the medium.

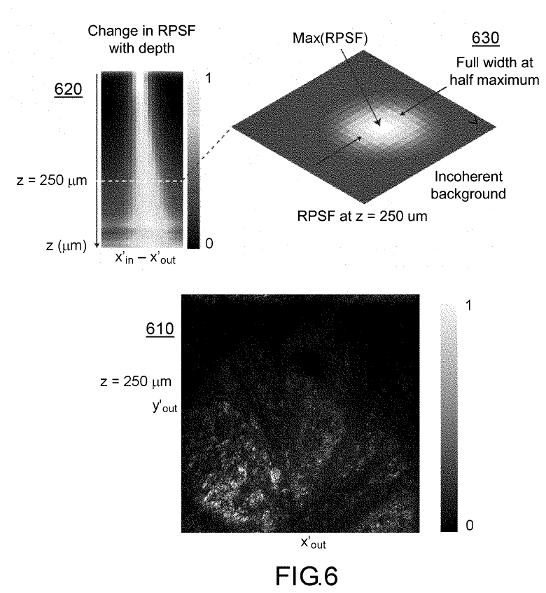

FIG. 6 shows the confocal image 610 obtained following this process of numerically focusing the data. It should be noted that the image can thus be constructed according to depth z instead of time of flight t, which is a limitation of conventional OCT images in which the axial dimension is dictated by the path difference between the interferometer arms.

Comparison with the previous confocal image ℑ′(r) (304, FIG. 3B) illustrates the gain in image quality, both in terms of contrast and resolution.

However, the quality of this image can still be improved due to aberration phenomena (excluding focusing defects) and multiple scattering.

FIG. 6 illustrates this last assertion by showing a quantitative study of the RPSF measured in the cornea after focusing. In particular, it shows the change with depth 620 in the radial distribution of the RPSF around the confocal point Δrₘₐₓ. The extent of the confocal peak increases with depth, quantifying the loss of resolution brought about by aberrations experienced by the light wave as it propagates through the sample. By way of example, the extension of the RPSF at half-maximum 630 is 15 μm at a depth z=250 μm, which is well above the diffraction limit (δp˜1.4 μm). Finally, the change with depth in the RPSF shows the emergence of an increasingly incoherent background beyond z=200 μm. This is resistant with respect to an average over the integration time of the camera; this component is deterministic and is therefore linked to the occurrence of multiple scattering events upstream of the focal plane.

Beyond their change with depth, the levels of aberration and multiple scattering can also be probed transversally by studying the RPSFs measured locally around a set of points rₚ in the field of view.

FIG. 7A illustrates the subdivision of the field of view carried out in order to extract the local RPSFs shown in FIG. 7C. The spatial extent of the local RPSFs shows, for example, that focusing quality is much better in the lower left of the field of view. The confocal image shown in FIG. 6 is therefore a much better estimator of the reflectivity of the medium in this part of the field of view. The transverse change in the RPSFs also shows the non-isoplanatic character of the aberrations brought about by the optical index heterogeneities distributed through the sample. As will be seen later on, local compensation for aberrations is advantageous, and the matrix approach is a suitable tool for this.

Beyond the aberrations, a rate of multiple scattering over single scattering can be measured using the confocal intensity RPSFₘₐₓ and the incoherent background RPSF_{bg}:

$${ρ}_{MS} ( {r}_{p} ) = \frac{{RPSF}_{bg} ( {r}_{p} )}{{RPSF}_{max} ( {r}_{p} ) - 2 \times {RPSF}_{bg} ( {r}_{p} )} \qquad [ Math 13 ]$$

The factor 2 in the denominator takes into account the effect of coherent backscattering, which gives rise to confocal amplification of the multiply scattered intensity by this same factor 2. FIG. 7B shows a map of the parameter ρ_{MS} at depth z=250 μm. This map reveals the presence of striations which were already more or less visible in the confocal image in FIG. 6. Such striations in the stroma of the cornea are characteristic of diseases such as keratoconus. Beyond this qualitative analysis, the ratio ρ_{MS} is a first step towards a quantitative, local image of the light scattering properties in biological samples. Depending on the information sought, other parameters can be extracted, such as the single scattering rate (or confocal scattering rate):

$${ρ}_{S} ( {r}_{p} ) = \frac{{RPSF}_{max} ( {r}_{p} )}{{RPSF}_{max} ( {r}_{p} ) + {RPSF}_{bg} ( {r}_{p} )} \qquad [ Math 14 ]$$

The decrease of this parameter with z makes it possible to locally quantify the scattering mean free path in the medium. More generally, the quantification of single and multiple scattering phenomena allows transport parameters such as the scattering mean free path, the transport mean free path or the scattering coefficient to be measured locally. The reflection matrix approach also allows the growth of the diffuse halo to be studied at relatively short times of flight, giving much better spatial resolution than standard techniques such as diffuse optical tomography.

Beyond the quantification of aberration and multiple scattering phenomena in the medium, it will now be shown how, using the numerically refocused reflection matrix, it is possible to locally compensate for aberrations caused by the sample in order to obtain a confocal image with optimal contrast and resolution close to the diffraction limit.

To do this, the entrance/exit emitting matrices Tᵢₙ/ₒᵤₜ between an entrance/exit correction base and the voxels of the medium can be estimated. To this end, a local analysis is carried out here in order to estimate suitable focusing laws for each voxel of the image.

By way of illustration, the plane wave base is chosen as the correction base. The first step in the matrix correction process for correcting aberrations is to project the time-windowed focused reflection matrix, R [symbol] (t=2nz/c₀), at exit (or entrance) into this correction base via simple spatial Fourier transform:

$$\overline{R} ( {k}_{out} , {r}_{in} ) = {\sum }_{{ρ}_{out}} R ( \{ {ρ}_{out}^{′} , z \} , \{ {ρ}_{out}^{′} , z \} , t = 2 nz / {c}_{0} ) {e}^{- {ik}_{out} , {ρ}_{out}^{′}} \qquad [ Math 15 ]$$

From this dual matrix R̅ₖᵣ, a distortion matrix Dₖᵣ is constructed, defined as follows:

$$D ( {k}_{out} , {r}_{in} ) = \overline{R} ( {k}_{out} , {r}_{in} ) \times {T}_{0} ( {k}_{out} , {r}_{in} ) \qquad [ Math 16 ]$$

where T₀ is a reference matrix that models propagation of plane waves if the medium were homogeneous (i.e. without aberrations): T₀(kₒᵤₜ, rᵢₙ)=e^{-ik}^{ₒᵤₜ}^{r}^{ᵢₙ}. In Ref [4], it was shown how, under an isoplanatic assumption, a singular-value decomposition of the matrix D made it possible to estimate the transmittance A(Kₒᵤₜ) of the aberrator from the phase of its first eigenvector U₁. Here, since the aberrations are not spatially invariant, subdivision of the field of view is advantageous in order to locally analyze the distortion matrix and locally estimate suitable focusing laws for each voxel of the image. The field of view is divided into overlapping regions defined by their central midpoint rₚ and their spatial extension Δr. All of the distorted components of the field that are associated with the focal points rᵢₙ located in each region can be extracted and stored in a local distortion matrix:

$${D}^{′} ( {k}_{out} , {r}_{in} , {r}_{p} ) = D ( {k}_{out} , {r}_{in} ) {W}_{Δ r} ( {r}_{in} - {r}_{p} ) \qquad [ Math 17 ]$$

where W_{Δr}(r)=1 pour |x′|<Δx, |y|<Δy et |z′|<Δz, and zero otherwise. Ideally, each local distortion matrix should contain a set of focal points rᵢₙ belonging to the same isoplanatic spot. In reality, the isoplanarity condition is never completely fulfilled. A delicate compromise must therefore be made with regard to the size Δr of the spatial window W_{Δr}: it must be small enough to approximate the isoplanarity condition, but large enough to encompass a sufficient number of independent realizations of the disorder. An SVD of each local distortion matrix D′(rₚ) gives a first exit eigenvector U₁(rₚ)=[U₁ (kₒᵤₜ, rₚ)]. An estimator \hat{T}ₒᵤₜ of the transmission matrix Tₒᵤₜ=[Tₒᵤₜ(kₒᵤₜ, rₚ)] is thus constructed:

$${\hat{T}}_{out} ( {k}_{out} , {r}_{p} ) = {T}_{0} ( {k}_{out} , {r}_{p} ) \times {e}^{jarg \{ {U}_{1} ( {k}_{out} , {r}_{p} ) \}} \qquad [ Math 18 ]$$

Another estimator of the transmission matrix Tₒᵤₜ can be obtained via an iterative phase-reversal process. It is based on the following recurrence relation:

$${W}_{n + 1}^{T} ( {r}_{p} ) = exp \{ j arg \{ {D}^{′} ( {r}_{p} ) {D}^{′†} ( {r}_{p} ) {W}_{n} ( {r}_{p} ) \} \} \qquad [ Math 20 ]$$

where the exponent ^{T} denotes the matrix transposition operation and W₀(rₚ) corresponds to the initial transmittance chosen arbitrarily by the operator. This can be taken as homogeneous, W₀(rₚ)=[1 . . . 1]^{T} or determined on the basis of prior knowledge of the aberrations in the medium, in order to speed up convergence of the iterative process. Depending on the choice made by the operator, the iterative phase-reversal process can be iterated m times, and the resulting vector, Wₘ=[Wₘ(kₒᵤₜ, rₚ)], is an estimator of the transmittance of the aberrator at point rₚ. An estimator \hat{T}ₒᵤₜ of the transmission matrix Tₒᵤₜ=[Tₒᵤₜ(kₒᵤₜ, rₚ)] is thus constructed:

$${\hat{T}}_{out} ( {k}_{out} , {r}_{p} ) = {T}_{0} ( {k}_{out} , {r}_{p} ) \times {W}_{m} ( {r}_{p} ) \qquad [ Math 21 ]$$

Regardless of how the transmission matrix Tₒᵤₜ is estimated, the phase conjugate of the estimator \hat{T}ₒᵤₜ is then applied to correct for aberrations at the exit of the medium and construct a new focused reflection matrix R̅ᵣᵣ=[R̅(ρₒᵤₜ, ρᵢₙ, z)] via the following matrix product:

$${\overline{R}}_{rr} ( z ) = {\hat{T}}_{out}^{†} \times {\overline{R}}_{kr} ( z ) \qquad [ Math 22 ]$$

where the symbol † corresponds to a transconjugation of the matrix \hat{T}ₒᵤₜ. The same process can be repeated at entrance to estimate the transmission matrix Tᵢₙ and iterated by gradually decreasing the extension Δr of the spatial windows in order to correct for aberrations of higher and higher order associated with smaller and smaller isoplanatism patches. At the end of the matrix aberration correction process, a corrected confocal image is obtained from the diagonal elements of the matrices R̅ᵣᵣ(z):

$$( r ) = \overline{R} ( r , r ) \qquad [ Math 23 ]$$

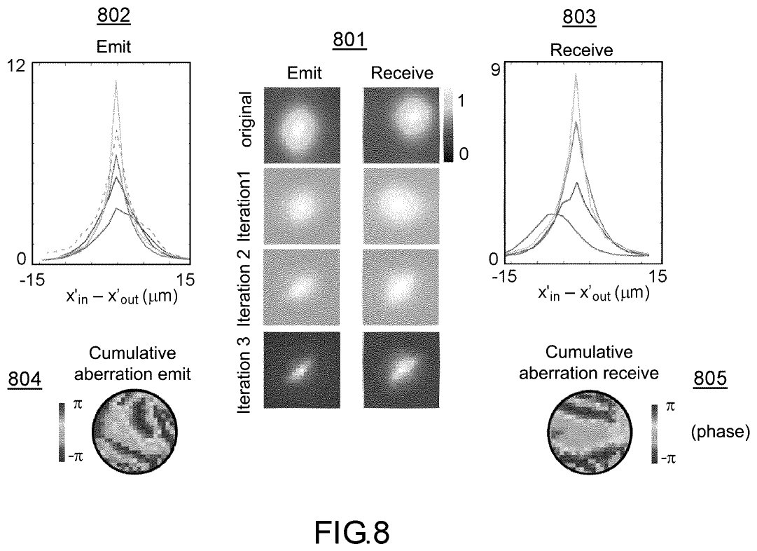

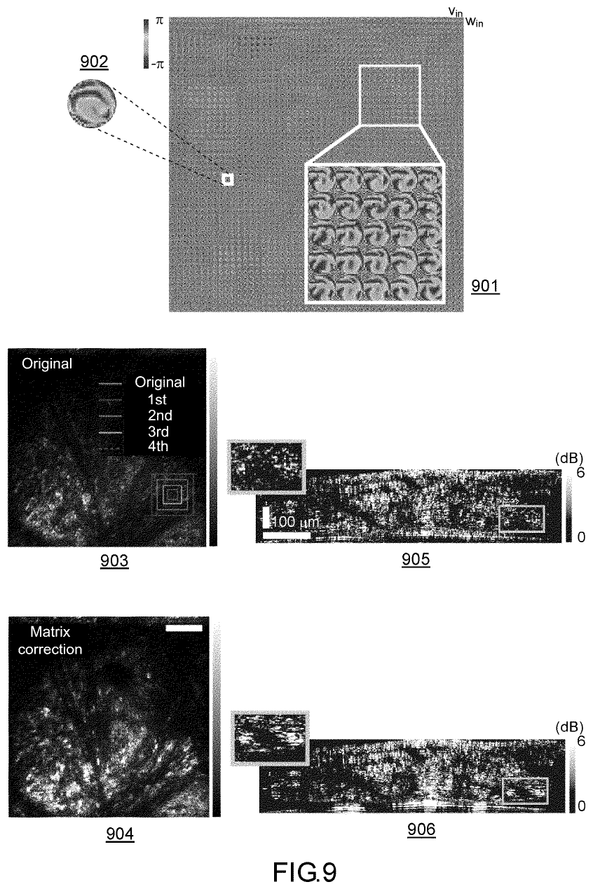

FIG. 8 shows the result of the method for the numerical correction of transverse aberrations in the cornea at depth z=250 μm. An iterative phase-reversal method is considered here to estimate the transmission matrices Tₒᵤₜ and Tᵢₙ.

FIG. 8 shows the change 801, 802, 803 in the RPSF on each iteration for a sub-zone of the field of view of 105×105 μm². As entrance and exit iterations progress, the RPSF becomes more refined, as increasingly local aberrations are corrected. The aberration laws 804, 805 obtained at entrance and exit at the end of the process are also shown in FIG. 8. In an ideal case, because of spatial reciprocity, they should be identical (Tᵢₙ=Tₒᵤₜ). They differ in particular due to imperfections in the imaging system, such as alignment defects. The matrix aberration correction process therefore not only corrects aberrations brought about by optical index heterogeneities in the medium, but also imperfections in the imaging system. Comparison of the confocal images of the sub-zone before and after correction, ℑ′(r)et ℑᵣ(r), illustrates the benefits of transverse aberration correction after axial aberration correction.

FIG. 9 shows the phase of the transmission matrix Tᵢₙ obtained at the end of the iterative aberration correction process (901, 902). This contains all of the aberration laws for each sub-zone of the field of view (FIG. 7A). Images 903, 904 show a face-on section of the volumetric confocal image of the cornea at depth z=250 μm before and after numerical aberration correction. Images 905, 906 show a longitudinal section (B-scan) of the volumetric confocal image of the cornea before and after numerical aberration correction. The confocal image appears much more contrasty after matrix aberration correction: confocal intensity is increased by a factor of 7 on average over the field of view. The gain in resolution is also significant: the studying the RPSFs shows a refinement in resolution by a factor of 3.

The experimental validation tests were carried out using a characterization system of the type illustrated in FIG. 1A. Of course, other characterization systems in accordance with the present description are possible for implementing methods according to the present description.

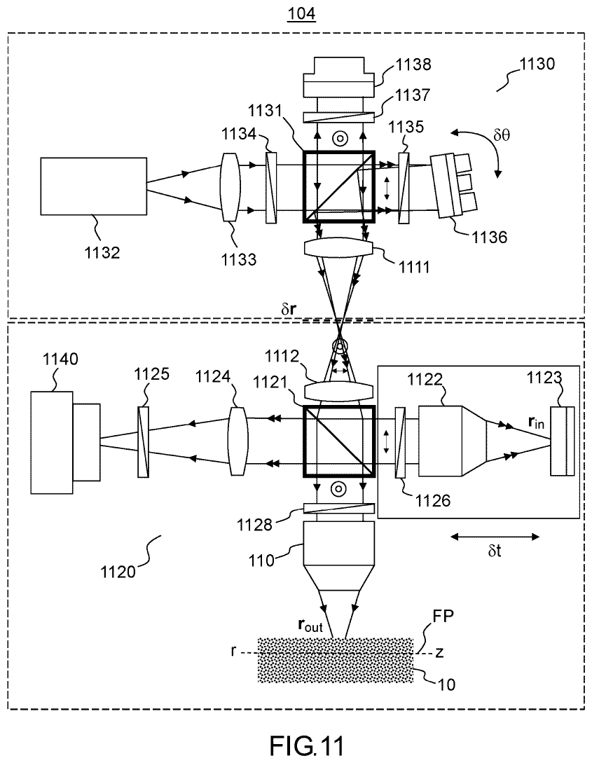

Thus, FIG. 10A, FIG. 10B and FIG. 11 show systems for the optical characterization of a sample formed of a bulk scattering medium, according to other exemplary embodiments.

In the example of the system 102 shown in FIG. 10A, one difference from the system shown in FIG. 1A lies in the field from the reference arm. The reference wave in the first interferometer comes directly from the source via the beam splitter 1032. For a fiber-based light source 132 (the case in FIG. 10A), the reference arm comprises an optical fiber 1033 and a collimator 1034 allowing a reference wave to be projected in the form of a plane wave at the detector 140. In free space, the reference arm would be made up of a lens system ideally chosen to minimize the path difference between the reference wave and the waves scattered singly by the reflectors located in a plane of interest in the sample arm. In this case, the interference between the wave reflected by the sample, illuminated by a set of predetermined different incident wavefronts, and a reference plane wave that varies only in frequency, is measured. This gives direct access to the backscattered field E [symbol] (ρₒᵤₜ, uᵢₙ, ω) backscattered by the sample. By numerically multiplying this field by a reference field

$$\text{?} ( {p}_{out} \text{?} {u}_{in} , ω ) ,$$

$$\text{?} \text{indicates text missing or illegible when filed}$$

the matrix \tilde{R}_{ρu}=[\tilde{R}(ρₒᵤₜ, uᵢₙ, ω)], is obtained.

In the example of the system 103 illustrated in FIG. 10B, the source in question is a wide band source. Measurement of spectral dependence is made possible by the use of a detector 160 comprising a spectrometer. The spectrometer comprises, for example, a dispersive element 161 (e.g. a grating) and a detection device 162. Each element of the detection device measures the field at a coordinate ρₒᵤₜ of the plane ImP and at a frequency a>. The device measures a matrix \tilde{R}_{ρu}=[\tilde{R}(ρₒᵤₜ, uᵢₙ, ω)] at every point equivalent to that measured by the system of FIG. 1A.

A further example of a system for optically characterizing a bulk scattering medium according to the present description is shown schematically in FIG. 11. The system 104 shown in FIG. 11 has the advantage of being faster, in terms of acquisition time, and improved, in terms of signal-to-noise ratio, compared with the system shown in FIG. 1A, especially when it is desired to obtain a confocal image of the sample over a small number of cross sections of the sample.

The system 104 comprises an illuminating device 1130 with a spatially incoherent light source 1132 arranged at the focal point of a lens 1133, and configured to emit a plurality of incident light waves for illuminating, through the microscope objective 110, a given field of view of the sample 10. The system 104 also comprises a detector 1140, arranged at the focal point of a lens 1124, and a processing unit (not shown) which receives, in particular, the optoelectronic signals from the detector 1140. The characterization system 104 comprises two interferometers arranged in series. A first interferometer 1120 and a second interferometer which forms part of the illuminating device 1130. The second interferometer is, for example, a Michelson interferometer in air wedge configuration, which makes it possible to generate, at exit, two orthogonally polarized illuminating beams that are inclined with respect to one another. The first interferometer 1120 is, for example, a Linnik interferometer with a polarized beam splitter 1121 and quarter-wave plates 1126, 1128 on each arm. An afocal system 1111, 1112 makes it possible to conjugate the planes of the mirrors 1136 and 1138 of the second interferometer with the pupil planes of the microscope objectives 1122 and 110 of the first interferometer.

The spatially and temporally incoherent incident field is linearly polarized at 45 degrees to the directions parallel (e∥) and normal (e⊥) to the plane of the device, by means of a polarizer 1134. The components of this wave polarized in the directions e∥ and e⊥ are respectively transmitted and reflected by a polarized beam splitter 1131. Each arm of the second interferometer contains a quarter-wave plate (1135, 1137) and a mirror (1136, 1138). On one arm, the mirror (1136) is inclined with respect to the optical axis. On their return, the two waves from each arm leave the interferometer as two inclined, orthogonally polarized beams. However, these two beams are coherent with one another, since they are derived from the same incident wave.

In the first interferometer 1120, the two beams are again separated by the polarized beam splitter 1121. The e∥-polarized beam is transmitted in the reference arm. The e⊥-polarized beam is reflected in the object arm. The presence of quarter-wave plates 1126, 1128 on each of the two arms allows optimal transmission of the two beams once they have been reflected by the sample in the object arm and the mirror on the reference arm. These two beams are recombined at the exit of the interferometer using an analyzer 1125 polarized at 45 degrees with respect to e∥ and e⊥. They can thus interfere in the focal plane of the lens 1124. The detector, e.g. a CCD or CMOS camera, records the corresponding interference signal. The inclination of the mirror 1136 causes the reference and object beams to be shifted with respect to one another in the camera. In this way, it is possible to measure the impulse response between distinct points ρᵢₙ and ρₒᵤₜ. Thus, the system described by means of FIG. 11 makes it possible to measure a polychromatic reflection matrix Rₚₚ in the time domain and in a base conjugate with the focal plane of the objective of the microscope:

$$R ( {ρ}_{out} , {ρ}_{in} , t ) = \int d τ {E}_{s} ( {ρ}_{out} , {ρ}_{in} , τ ) \times E \text{?} ( {ρ}_{out} , {ρ}_{in} - {ρ}_{out} , τ - t ) \qquad [ Math 24 ]$$

$$\text{?} \text{indicates text missing or illegible when filed}$$

The time of flight t of the photons is controlled by the path difference between the reference and sample arms of the first interferometer 1120. The time of flight can therefore be scanned by simultaneously moving the elements 1122, 1123 and 1126 of the reference arm of the first interferometer. The relative position of the points ρᵢₙ and ρₒᵤₜ is controlled by the inclination of the reference mirror 1136 in the second interferometer.

In some exemplary embodiments, by performing Fourier transforms both temporally on the variable t and spatially on the coordinate ρₒᵤₜ on the coefficients of the matrix Rₚₚ, a \tilde{R}_{uρ}=[\tilde{R}(uₒᵤₜ, ρᵢₙ, ω)], matrix equivalent to that recorded by the device of FIG. 1A is obtained. Only the entrance and exit coordinates are switched. The same numerical treatment as described above can be applied simply by switching the exit and entrance coordinates of the matrix \tilde{R}_{ρu}.

In other embodiments, the focused reflection matrix Rᵣᵣ can be obtained on the basis of the matrix Rₚₚ by applying time shifts to the measured interference signals:

$$R ( {r}_{out} , {r}_{in} , t ) = {\sum }_{{ρ}_{out}} {\sum }_{{ρ}_{in}} {A}_{in} ( \text{} {ρ}_{in} , \text{} {r}_{in} ) \text{} {A}_{out} ( \text{} {ρ}_{out} , \text{} {r}_{out} ) \text{} R ( \text{} {ρ}_{out} , \text{} {ρ}_{in} , \text{} t - Δ \text{} t ( {ρ}_{in} , {r}_{in} ) - \text{} Δ t ( {ρ}_{out} , {r}_{out} ) ) \qquad [ Math 25 ]$$

where Aᵢₙ/ₒᵤₜ is a spatial apodization term of the field (related to the geometric decay of Green's functions in integral diffraction theory) and Δtᵢₙ/ₒᵤₜ is the time of flight associated with the ballistic photon propagating from the point rᵢₙ/ₒᵤₜ to the plane conjugate with the emitting (ρᵢₙ)/detection (ρₒᵤₜ) plane in the sample. This time-shifting operation is equivalent to the Fresnel propagator applied in the Fourier domain. If the data are acquired temporally, back-propagation of the measured field in the time domain may be more advantageous in terms of both time and memory than a shift to the frequency domain.

Although described by way of a number of detailed exemplary embodiments, the optical characterization methods and systems comprise various variants, modifications and improvements which will be obvious to those skilled in the art, it being understood that these various variants, modifications and improvements form part of the scope of the invention, as defined by the following claims.

### References

Ref 1: S. M. Popoff et al. “Measuring the Transmission Matrix in Optics”, Phys. Rev. Lett. 104, 100601, 2010.
Ref 2: A. Badon et al. “Smart optical coherence tomography for ultra-deep imaging through highly scattering media”, Sci. Adv. 2016; 2:el600370.
Ref.3: US20040061867
Ref. 4: US20210310787

1-15. (canceled)

16. A method for the optical characterization of a sample formed of a bulk scattering medium, the method comprising:
a step of positioning said sample in a field of view of a first microscope objective, said microscope objective being located in an object arm of a first interferometer, said first interferometer further comprising a reference arm;
a step of generating, by means of an illuminating device comprising a wide spectral band light source, a first plurality of Nᵢₙ incident light waves having different wavefronts;
for each incident light wave of given wavefront, a step of acquiring, by means of a detector (comprising Nₒᵤₜ elementary detectors, a second plurality (N_{ω}) of interference signals, each interference signal resulting from the interference, in a detection plane of the detector, between a wave backscattered by the sample illuminated by said incident light wave and a reference wave from the reference arm, said interference signals being acquired for N_{ω} different frequencies or N_{ω} different path differences between the backscattered wave and the reference wave;
determining a three-dimensional polychromatic reflection matrix R̅_{ρu}=[R̅(ρₒᵤₜ, uᵢₙ, ω)] of size Nᵢₙ×Nₒᵤₜ×N_{ω}, said three-dimensional polychromatic reflection matrix comprising all of the interference signals (Nᵢₙ×N_{ω}) acquired for the Nᵢₙ incident light waves and N_{ω} frequencies;
numerically determining, by applying a first propagator, on the basis of said polychromatic reflection matrix, at least a first focused volumetric reflection matrix (Rᵣᵣ), comprising a set of responses for the sample between source points and receiving points that are conjugate with voxels rᵢₙ(x′ᵢₙ, y′ᵢₙ, zᵢₙ) and rₒᵤₜ(x′ₒᵤₜ, y′ₒᵤₜ, zₒᵤₜ) of the sample (10) which are located at depths zᵢₙ and zₒᵤₜ in the sample, respectively;
determining, on the basis of said first focused volumetric reflection matrix, at least one map of a physical parameter of said sample.

17. The optical characterization method as claimed in claim 16, wherein said at least one map of a physical parameter of said heterogeneous medium comprises: a confocal image, a map of the point spread function around a plurality of reflection focal points (rₚ) (RPSF), a map of a single scattering rate, a map of a multiple scattering rate, a map of the optical index of the sample.

18. The optical characterization method as claimed in claim 16, the method further comprising:
determining, on the basis of said focused volumetric reflection matrix, a first reflection confocal image (ℑ(r));
determining, on the basis of said focused volumetric reflection matrix, a map of the spread function and determining a map of the position of the intensity maximum of each spread function;
determining, on the basis of the first reflection confocal image and said map of the position of the intensity maximum, a second reflection confocal image (ℑ′(r)) corrected for an alignment and/or focusing defect of the first interferometer.

19. The optical characterization method as claimed in claim 16, the method further comprising:
on the basis of said first focused volumetric reflection matrix, determining a plurality of maps of the spread function for a plurality of values of an integrated optical index of the sample;
on the basis of said plurality of maps of the spread function, determining a plurality of maps of the position of the intensity maximum of the spread function, each map being obtained for a value of the integrated optical index;
determining a map of the optimum value of the integrated optical index for which, at each focal point, the maximum intensity value of the spread function is the greatest;
numerically determining a second propagator based on said map of the optimum value of the integrated optical index; and
determining a second focused volumetric reflection matrix using said second propagator.

20. The method as claimed in claim 19, the method further comprising, on the basis of said map of the optimum value of the integrated optical index, determining a map of the optical index of the medium at each focal point.

21. The optical characterization method as claimed in claim 20, wherein said second propagator is determined on the basis of said map of the optical index.

22. The method as claimed in claim 19, the method further comprising:
determining, on the basis of the second focused volumetric reflection matrix, a distortion matrix (D) defined between a correction base and a focused base, comprising:
projecting, at entrance or at exit, the second focused volumetric reflection matrix, in the correction base, to obtain a projected reflection matrix (R̅ₖᵣ) at entrance or at exit, respectively;
determining the distortion matrix via term-by-term product between said projected reflection matrix and a reference reflection matrix, defined for a reference medium, in said correction base;
locally determining the invariants of said distortion matrix, in order to identify, in the correction base, aberration laws in sub-domains of the field of view;
estimating, on the basis of said aberration laws, a transmission matrix (Tₒᵤₜ) between voxels of the field of view and the correction base.

23. The optical characterization method as claimed in claim 16, wherein:
said light source is a variable-wavelength source and, for each incident light wave of predetermined wavefront, the interference signals of said second plurality (N_{ω}) of interference signals are acquired for N_{ω} central wavelengths of said incident light wave and a fixed path difference between the object arm and the reference arm of the first interferometer.

24. The optical characterization method as claimed in claim 16, wherein:
for each incident light wave of given wavefront, the interference signals of said second plurality (N_{ω}) of interference signals are acquired for N_{ω} path differences between the object arm and the reference arm of the first interferometer.

25. The optical characterization method as claimed in claim 16, wherein the Nᵢₙ incident light waves are spatially coherent and have wavefronts controlled by means for spatially shaping the wavefront.

26. The optical characterization method as claimed in claim 25, wherein said Nᵢₙ incident light waves of the first plurality of light waves are plane waves each having a wave vector with a different direction.

27. The optical characterization method as claimed in claim 16, wherein said light source is a low spatial coherence source, the method further comprising:
generating, on the basis of each spatially incoherent or partially coherent light wave from the light source, by means of a second interferometer, two polarized illumination waves with orthogonal polarizations and having a spatial shift in a plane conjugate with a focal plane (FP) of the first microscope objective;
varying said spatial shift to generate the Nᵢₙ incident waves of different wavefronts;
sending, for each spatial shift, said polarized waves with orthogonal polarizations to the object and reference arms of said first interferometer, respectively, by means of a polarization splitter element;
acquiring, by means of the detector, said second plurality (N_{ω}) of interference signals, each interference signal resulting from the interference, in the detection plane of the detector, between a wave backscattered by the sample illuminated by one of said polarized waves with orthogonal polarizations, and a reference wave generated by the reflection of the other of said polarized waves with orthogonal polarizations by a reference mirror of the reference arm, said interference signals being acquired for N_{ω} different path differences between the backscattered wave and the reference wave;
said polychromatic reflection matrix being determined on the basis of the set of the interference signals (Nᵢₙ×N_{ω}) acquired for the Nᵢₙ spatial shifts and N_{ω} path differences.

28. A system for the optical characterization of a sample formed of a bulk scattering medium, the system comprising:
a first interferometer with an object arm and a reference arm, the object arm comprising a first microscope objective with a given field of view in which, in operation, the sample is positioned;
an illuminating device comprising a wide spectral band light source, configured to generate a first plurality (Nᵢₙ) of incident light waves having different wavefronts;
a detector comprising Nₒᵤₜ elementary detectors, configured to acquire, for each incident light wave of given wavefront, a second plurality (N_{ω}) of interference signals, each interference signal resulting from the interference, in a detection plane of the detector, between a wave backscattered by the sample illuminated by said incident light wave and a reference wave from the reference arm, said interference signals being acquired for N_{ω} different frequencies or N_{ω} different path differences between the backscattered wave and the reference wave;
a processing unit configured to:
determine a three-dimensional polychromatic reflection matrix R̅_{ρu}=[R̅(ρₒᵤₜ, uᵢₙ, ω)] of size Nᵢₙ×Nₒᵤₜ×N_{ω} said three-dimensional polychromatic reflection matrix comprising all of the interference signals (Nᵢₙ×N_{ω}) acquired for the Nᵢₙ incident light waves and N_{ω} frequencies;
numerically determine, by applying a first propagator, on the basis of said polychromatic reflection matrix, at least a first focused volumetric reflection matrix (Rᵣᵣ), comprising a set of responses for the sample between source points and receiving points that are conjugate with voxels rᵢₙ(x′ᵢₙ, y′ᵢₙ, zᵢₙ) and rₒᵤₜ(x′ₒᵤₜ, y′ₒᵤₜ, zₒᵤₜ) of the sample which are located at depths zᵢₙ and zₒᵤₜ in the sample, respectively;
determining, on the basis of said first focused volumetric reflection matrix, at least one map of a physical parameter of said sample.

29. The optical characterization system as claimed in claim 28, wherein said first interferometer is a Linnik interferometer and the reference arm comprises a reference mirror and a second microscope objective.

30. The system as claimed in claim 28, wherein:
the light source is a low spatial coherence source; and the illuminating device comprises
a second interferometer configured to generate, on the basis of each spatially incoherent or partially coherent light wave from the light source, two polarized illumination waves with orthogonal polarizations and having a spatial shift in a plane conjugate with a focal plane of the first microscope objective; and
means for varying the spatial shift; and wherein
said first interferometer is a Linnik interferometer and comprises
a polarization splitter element configured to send, to the object and reference arms, respectively, each of said polarized waves with orthogonal polarizations and having said spatial shift;
means for varying the path difference between the reference arms; and wherein
each interference signal of said second plurality (N_{ω}) of interference signals results from the interference, in the detection plane of the detector, between a wave backscattered by the sample illuminated by one of said polarized waves with orthogonal polarizations, and a reference wave generated by the reflection of the other of said polarized waves with orthogonal polarizations by a reference mirror of the reference arm, said interference signals being acquired for N_{ω} different path differences between the backscattered wave and the reference wave;
said polychromatic reflection matrix is determined on the basis of the set of the interference signals (Nᵢₙ×N_{ω}) acquired for the Nᵢₙ spatial shifts and N_{ω} path differences.
